(19) United States
(12) Patent Application Publication
(10) Pub. No.: US 2018/0211282 A1
(43) Pub. Date: Jul. 26, 2018

(54) SYSTEM, METHOD, AND COMPUTER PROGRAM PRODUCT FOR DETERMINING WHETHER TO PROMPT AN ACTION BY A PLATFORM IN CONNECTION WITH A MOBILE DEVICE

(71) Applicant: Majen Tech, LLC, Longview, TX (US)

(72) Inventors: George Andrew Gordon, Frisco, TX (US); Joseph A Cerrato, Longview, TX (US); Ronald A Johnston, Longview, TX (US); Kevin J Zilka, Los Gatos, CA (US)

(21) Appl. No.: 15/925,737

(22) Filed: Mar. 19, 2018

Related U.S. Application Data
(63) Continuation-in-part of application No. 14/050,332, filed on Oct. 9, 2013.
Application No. 14/050,332 is a continuation-in-part of application No. 13/652,458, filed on Oct. 15, 2012.
Application No. 13/652,458 is a continuation-in-part of application No. 15/426,022, filed on Feb. 6, 2017.
Application No. 15/426,022 is a continuation-in-part of application No. 13/685,698, filed on Nov. 26, 2012, now abandoned.
(60) Provisional application No. 62/644,589, filed on Mar. 18, 2018.
(60) Provisional application No. 61/711,727, filed on Oct. 9, 2012.
(60) Provisional application No. 61/728,803, filed on Nov. 20, 2012.
(60) Provisional application No. 61/748,371, filed on Jan. 2, 2013.
(60) Provisional application No. 61/612,960, filed on Mar. 19, 2012.
(60) Provisional application No. 61/599,920, filed on Feb. 16, 2012.
(60) Provisional application No. 61/577,657, filed on Dec. 19, 2011.
(60) Provisional application No. 61/567,118, filed on Dec. 5, 2011.
(60) Provisional application No. 61/547,638, filed on Oct. 14, 2011.
(60) Provisional application No. 61/596,174, filed on Feb. 7, 2012.
(60) Provisional application No. 61/591,819, filed on Jan. 27, 2012.
(60) Provisional application No. 61/590,764, filed on Jan. 25, 2012.
(60) Provisional application No. 61/590,767, filed on Jan. 25, 2012.
(60) Provisional application No. 61/563,741, filed on Nov. 25, 2011.

(51) Int. Cl. G06Q 30/02

(52) U.S. Cl. CPC G06Q 30/0262; G06Q 30/0267

(57) ABSTRACT

A system, method, and computer program product are provided for determining whether to prompt an action by a platform in connection with a mobile device. In operation, action criteria is received utilizing a platform capable of advertising. Additionally, information from an application is received by the platform. Further, it is determined whether to prompt an action by the platform in connection with a mobile device, based on the action criteria and the information.

### RELATED APPLICATION(S)

The present application is continuation-in-part of U.S. application Ser. No. 13/652,458, filed Oct. 15, 2012, which, in turn, claims priority from U.S. Provisional Application No. 61/547,638, filed Oct. 14, 2011, U.S. Provisional Application No. 61/567,118 dated Dec. 5, 2011, U.S. Provisional Application No. 61/577,657 dated Dec. 19, 2011, U.S. Provisional Application No. 61/599,920 dated Feb. 16, 2012, and U.S. Provisional Application No. 61/612,960 dated Mar. 19, 2012, all of which are incorporated herein by reference in their entirety for all purposes.

The present application is a continuation-in-part of U.S. patent application Ser. No. 15/426,022, titled SYSTEM, METHOD, AND COMPUTER PROGRAM PRODUCT FOR PRESENTING DECISION-RELATED INFORMATION, filed Feb. 6, 2017 which, in turn, is a continuation-in-part of, and claims priority to U.S. patent application Ser. No. 13/685,698, titled SYSTEM, METHOD, AND COMPUTER PROGRAM PRODUCT FOR DISPLAYING A PLURALITY OF PRODUCT INFORMATION ASSOCIATED WITH DIFFERENT E-COMMERCE SITES, filed Nov. 26, 2012 which claims priority from U.S. Provisional Application No. 61/563,741 (Attorney Docket No.: SVIPGP134+), titled SYSTEM, METHOD, AND COMPUTER PROGRAM PRODUCT FOR PRESENTING DECISION RELATED INFORMATION, filed Nov. 25, 2011, U.S. Provisional Application No. 61/590,764 (Attorney Docket No.: SVIPGP134+(2)), titled SYSTEM, METHOD, AND COMPUTER PROGRAM PRODUCT FOR PRESENTING INFORMATION TO A USER BASED ON DETERMINED SATISFACTION-RELATED INFORMATION ASSOCIATED WITH THE USER, filed Jan. 25, 2012, U.S. Provisional Application No. 61/591,819 (Attorney Docket No.: SVIPGP140+), titled SYSTEM, METHOD, AND COMPUTER PROGRAM PRODUCT FOR ALTERING AT LEAST ONE ASPECT OF AN INTEGRATED E-COMMERCE ON-LINE APPLICATION, filed Jan. 27, 2012, U.S. Provisional Application No. 61/596,174 (Attorney Docket No.: SVIPGP140+(2)), titled SYSTEM, METHOD, AND COMPUTER PROGRAM PRODUCT FOR ALTERING AT LEAST ONE ASPECT OF AN INTEGRATED E-COMMERCE ON-LINE APPLICATION, filed Feb. 7, 2012, U.S. Provisional Application No. 61/590,767 (Attorney Docket No.: SVIPGP138+), titled SYSTEM, METHOD AND COMPUTER PROGRAM PRODUCT FOR LOCATION-SPECIFIC PRIVACY SETTINGS, filed Jan. 25, 2012, and U.S. Provisional Application No. 62/455,548 (Attorney Docket No.: SVIPGP160+), titled SYSTEM, METHOD, AND COMPUTER PROGRAM PRODUCT FOR PRESENTING DECISION-RELATED INFORMATION, filed Feb. 6, 2017, all of which are incorporated herein by reference in their entirety for all purposes.

The present application is a continuation-in-part of and claims priority to U.S. patent application Ser. No. 14/050,332, filed Oct. 9, 2013 (published under US 2018-0032997 A1) which, in turn, claims priority to U.S. Prov. Patent Application No. 61/711,727, filed Oct. 9, 2012; U.S. Prov. Patent Application No. 61/728,803, filed Nov. 20, 2012; and U.S. Prov. Patent Application No. 61/748,371, filed Jan. 2, 2013; all of which are incorporated herein by reference in their entirety for all purposes. The present application also claims priority to U.S. Prov. Patent Application No. 62/644,589, filed Mar. 18, 2018, all of which is incorporated herein by reference in its entirety for all purposes.

### FIELD OF THE INVENTION AND BACKGROUND

The present invention relates to mobile devices, and more particularly to providing content to such devices.

### SUMMARY

A system, method, and computer program product are provided for determining whether to prompt an action by a platform in connection with a mobile device. In operation, action criteria is received utilizing a platform capable of advertising. Additionally, information from an application is received by the platform. Further, it is determined whether to prompt an action by the platform in connection with a mobile device, based on the action criteria and the information.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for determining whether to prompt an action by a platform in connection with a mobile device, in accordance with one embodiment.

FIG. 4 shows a system for prompting an action by a platform in connection with a mobile device, in accordance with another embodiment.

FIG. 5 shows a system for contextual advertisement management in connection with a mobile device, in accordance with another embodiment.

FIG. 6 shows a system for downloading/executing feeder applications in connection with a mobile device, in accordance with another embodiment.

FIG. 7 shows a mobile device interface for downloading/executing feeder applications in connection with a mobile device, in accordance with another embodiment.

FIG. 8 shows a method for presenting contextual advertisements, in connection with a mobile device, in accordance with another embodiment.

FIG. 9 shows a method for presenting contextual advertisements, in connection with a mobile device, in accordance with another embodiment.

FIG. 10 shows a method for presenting contextual advertisements, in connection with a mobile device, in accordance with another embodiment.

FIG. 11 shows a mobile device interface for displaying advertisements/content, in accordance with another embodiment.

FIG. 12 shows a mobile device interface for displaying advertisements/content, in accordance with another embodiment.

FIG. 13 shows a mobile device interface for displaying advertisements/content, in accordance with another embodiment.

FIG. 14 shows a mobile device interface for displaying advertisements/content, in accordance with another embodiment.

FIG. 15 shows a mobile device interface for configuring advertisement/content display, in accordance with another embodiment.

FIG. 16 shows a mobile device interface for configuring advertisement/content related notifications, in accordance with another embodiment.

FIG. 17 shows a mobile device interface for configuring advertisement/content related notifications, in accordance with another embodiment.

FIG. 18 shows a mobile device interface for configuring advertisement/content related settings, in accordance with another embodiment.

FIG. 19 shows an advertisement interface flow, in accordance with another embodiment.

FIG. 20 shows an advertisement interface, in accordance with another embodiment.

### DETAILED DESCRIPTION

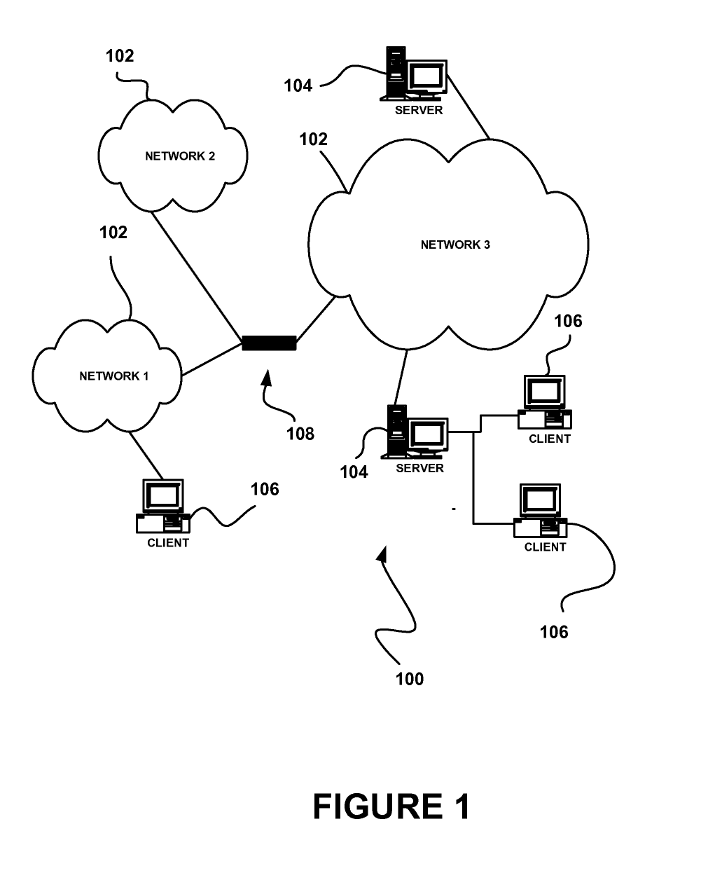

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g., printer, etc.), any component of a computer, and/or any other type of logic. In order to facilitate communication among the networks 102, at least one gateway 108 is optionally coupled therebetween.

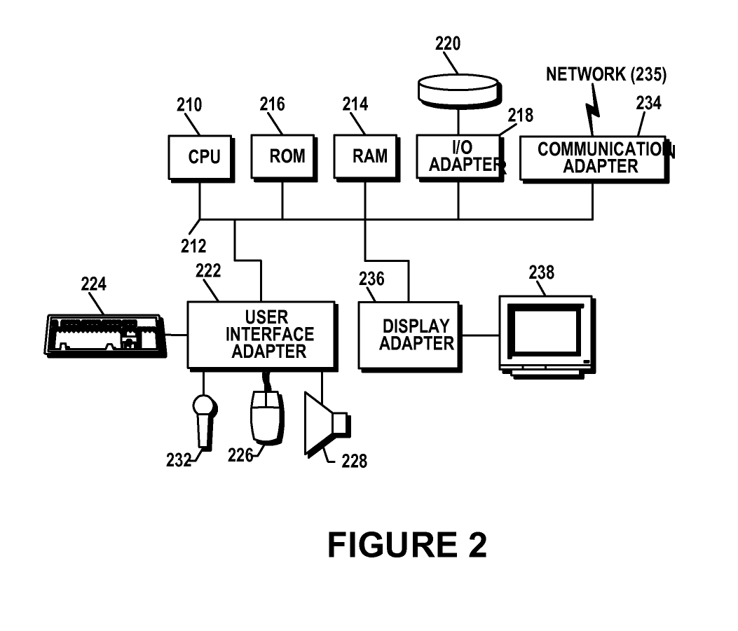

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

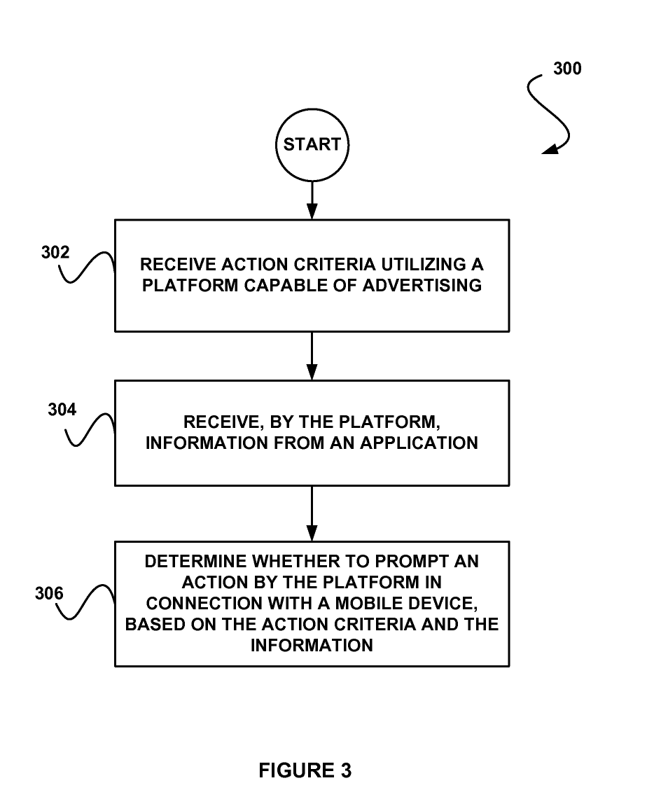

FIG. 3 shows a method 300 for determining whether to prompt an action by a platform in connection with a mobile device, in accordance with one embodiment. As an option, the method 300 may be implemented in the context of the architecture and environment of the previous Figures and/or any subsequent Figure(s). Of course, however, the method 300 may be carried out in any desired environment.

As shown, action criteria is received utilizing a platform capable of advertising. See operation 302. Additionally, information from an application is received by the platform. See operation 304. Further, it is determined whether to prompt an action by the platform in connection with a mobile device, based on the action criteria and the information. See operation 304.

The mobile device may include any type of mobile device, including a cellular phone, a tablet computer, a handheld computer, a media device, a mobile device associated with a vehicle, a PDA, an e-reader, and/or any other type of mobile device.

The platform capable of advertising may include may include any type of platform capable of presenting (e.g., displaying, audibly outputting, etc.) advertisements and/or causing any such presentation of advertisements on or off the platform. In various embodiments, the platform may or may not receive the advertisements from a separate advertiser. For example, in various embodiments, the platform may include a social network platform, an operating system platform, a retailer platform, a mobile wallet application platform, a search engine platform, a gaming platform, an entertainment and/or media (e.g., music, video, pictures, etc.) platform, a networked application platform, a locally stored application platform, and/or various other platforms.

The action criteria may include any type of action criteria. For example, in various embodiments, the action criteria may involve at least one of aggregated data collected from a plurality of users, machine-related data, location data, payment data, social data, application usage data, event data, and/or search data. In one embodiment, the action criteria may involve information associated with a social network service. In another embodiment, the action criteria may involve information associated with a browser. In another embodiment, the action criteria may involve information associated with a calendar. In another embodiment, the action criteria may involve information associated with an online retailer. In another embodiment, the information may involve information associated with a mobile payment service and/or application.

Additionally, the action prompted may include an advertisement, a suggestion, incentive, useful information, a utilitarian function, and/or any type of an output. Useful information and/or utilitarian function may include, but are not limited to passes (e.g., boarding or travel passes, etc.), tickets (e.g., movie or event tickets, etc.), commerce-related programs/cards (e.g., loyalty program/cards, etc.), etc. In the context of the present description, an advertisement may include anything (e.g., media, deal, coupon, suggestion, helpful information/utility, etc.) that has at least a potential of incentivizing or persuading or increasing the chances that one or more persons will purchase a product or service. In one embodiment, the action criteria may be received from an advertiser and the action may include displaying an advisement. In one embodiment, the advertisement may be displayed in a non-intrusive manner. For example, in one embodiment, the action (e.g., advertisement, etc.) may be manifested utilizing a lock screen of the mobile device. In another embodiment, the action (e.g., advertisement, etc.) may be manifested during an unlocking of a lock screen of the mobile device. In still other embodiments, the action (e.g., advertisement, etc.) may be manifested in a manner that is integrated in any regular usage of the mobile device. Of course, any such manifestation of the aforementioned action may be presented in any manner that reduces an intrusiveness of a presentation thereof.

Further, in one embodiment, the action (e.g., advertisement, etc.) may be manifested when it is determined a user of the mobile device is available to view the advertisement. For example, in one embodiment, the action (e.g., advertisement, etc.) may be conditionally manifested based on a facial recognition in connection with a user of the mobile device. In one embodiment, if it is determined that the user is viewing the mobile device, utilizing facial recognition, the action (e.g., advertisement, etc.) may be manifested utilizing the mobile device.

Additionally, the application may include any type of online or locally stored application. In various embodiments, the application may include a social network application, a dating service application, an on-line retailer application, a browser application, a gaming application, a media application, an application associated with a product, an application associated with a location, an application associated with a store (e.g., an online store, a brick and mortar store, etc.), an application associated with a service, an application associated with a company, any application that performs, causes, or facilitates the aforementioned action(s), and/or any other type of application including, but not limited to those disclosed herein.

In one embodiment, the application may be available via the platform. For example, in various embodiments, the application may be available in via a social network platform, an operating system platform, a retailer platform, a mobile wallet application platform, a networked application platform, a locally stored application platform, any platform that performs, causes, or facilitates the aforementioned action(s), and/or various other platforms. This may be accomplished, for example, via an application store or center or interface where a plurality of application are available for selection (and possibly for purchase), for use on or off the platform.

When used “on” the platform, the application may be executed, accessed, etc. after (and/or conditioned upon) executing, accessing, etc. (e.g., logging in, etc.) the platform, and possibly in the context of (or during simultaneous usage of) the platform. This may or may not be accomplished by framing the application with platform graphical user interface component or simply branding at least a portion of the application with platform branding. When used “off” the platform, the application may be executed, accessed, etc. in a manner that is less connected with the platform.

Further, in one embodiment, the application may be available in connection with a machine. The machine may include any type of machine. For example, in various embodiments, the machine may include a machine associated with a vehicle (e.g., a vehicle heads-up display, an entertainment system, etc.), a television, a set-top box, a computer, a display unit, a machine associated with a retailer/service provider, a machine associated with a business, and/or any other machine.

More illustrative information will now be set forth regarding various optional architectures and features with which the foregoing techniques discussed in the context of any of the present or previous figure(s) may or may not be implemented, per the desires of the user. For instance, various optional examples and/or options associated with the action criteria of operation 302, the information of operation 304, the prompting of the action of operation 306, and/or other optional features have been and will be set forth in the context of a variety of possible embodiments. It should be strongly noted, however, that such information is set forth for illustrative purposes and should not be construed as limiting in any manner. Any of such features may be optionally incorporated with or without the inclusion of other features described.

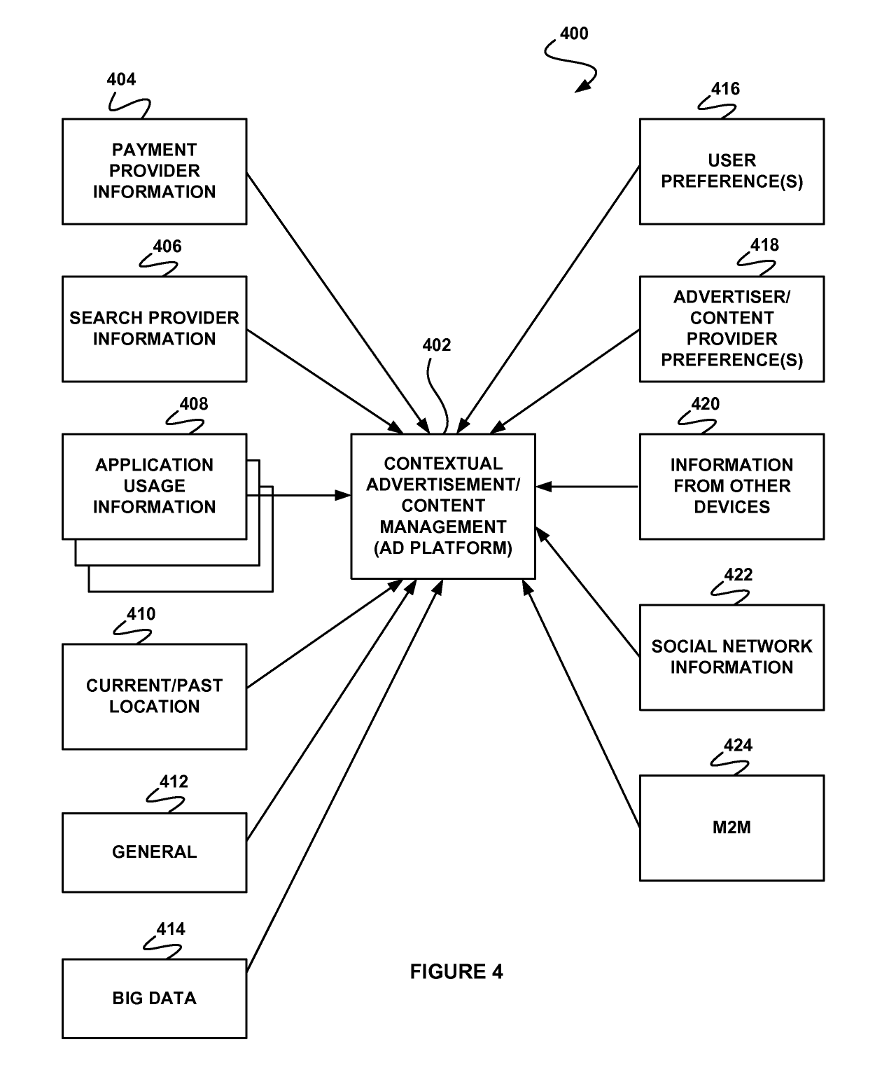

FIG. 4 shows a system 400 for prompting an action by a platform in connection with a mobile device, in accordance with another embodiment. As an option, the system 400 may be implemented in the context of the architecture and environment of the previous Figures and/or any subsequent Figure(s). Of course, however, the system 400 may be implemented in the context of any desired environment. It should also be noted that the aforementioned definitions may apply during the present description.

As shown, a contextual advertisement/content management platform or module (AD platform) 402 is in communication with one or more other modules or platforms 404-424. In various embodiments, the AD platform 402 may include software (e.g., computer code, etc.) and/or hardware (e.g., one or more servers, one or more processors, one or more databases, etc.). Additionally, in various embodiments, the AD platform 402 may decision logic capable of determining advertisements and/or content to be output, selected, and/or displayed. For example, in one embodiment, the AD platform 402 may utilize information provided by the other modules/platforms 404-424 to determine advertisements and/or content to be output, selected, and/or displayed to one or more users of a mobile device. While the present embodiments and subsequent embodiments may or may not involve advertisements and/or content delivery, it should be strongly noted that, in any of the embodiments disclosed herein, other actions (e.g., see, for example, those disclosed in connection with FIG. 3, etc.) may be substituted for such advertisements and/or content. To this end, the AD platform 402 may just as readily be considered an action platform, in various embodiments.

The modules/platforms 404-424 may include any type of module/platform capable of providing information to the AD platform 402. While the modules/platforms 404-424 are shown to be discrete from the AD platform 402 in the embodiment of FIG. 4, it should be noted that any amount (e.g., partial, full, etc.) of integration may or may not be implemented with respect to any one or more or all of the modules/platforms 404-424 and the AD platform 402. Still yet, the AD platform 402 may or may not be integrated with any of the platforms disclosed herein (e.g., see platforms disclosed in connection with the description of FIG. 3, etc.).

For example, in various embodiments, the modules/platforms 404-424 may include, but are not limited to modules/platforms configured to provide payment provider information (e.g., user billing information, user awards point information, purchase information, etc.—see, for example, U.S. Pat. No. 8,127,982, U.S. Pat. No. 8,239,276, US 2002/0179704A1 filed Jun. 5, 2001, which are each incorporated herein by reference), search provider information (e.g., search query terms, search results, etc.), application usage information (e.g., information associated with the types of applications used, information provided to applications, information gleaned from applications, information determined by applications, stored information associated with applications, information collected by the application from other platforms, applications, etc.), information associated with a current or past location associated with a device and/or a user (e.g., IP address information, GPS information, cellular network information, social network check-in information, etc.), general information (e.g., general information associated with a device, general information associated with a user, etc.), big data information (e.g., mobile device generated or logged data, user generated or logged data, automobile generated or logged data, etc.), and/or various other information.

As additional examples, the modules/platforms 404-424 may include, but are not limited to modules/platforms configured to provide user preference information (e.g., user product preferences, user setting preferences, user advertisement preferences, user personal preferences, etc.), advertiser/content preference information (e.g., advertisement/content selection hierarchy, advertisement/content output/display preferences, etc.), information from other devices (e.g., mobiles phones, tablet computers, desktop computers, televisions, vehicles or vehicle computers, machines associated with a business, etc.), social network information (e.g., user provided information, posted information, “Like” information, membership information, demographic information, friend information, career information, hobby information, marital information, location information, etc.), machine to machine (M2M) information (e.g., protocol preference information, device ID information, etc.), and/or various other information.

In various embodiments, the modules/platforms 404-424 may include software and/or hardware. In one embodiment, the modules/platforms 404-424 may represent software applications. In this case, in various embodiments, the applications may be stored on one or more devices (e.g., one or more mobile devices, one or more network devices, etc.) and/or on one or more servers (e.g., a social network server, an advertisement server, etc.). Further, in various embodiments, the applications may include applications that are automatically executable (e.g., based on location, based on an action, etc.), and/or capable of being executed by a user (e.g., the user of a mobile device, etc.).

In one embodiment, the modules/platforms 404-424 may provide the AD platform 402 with information automatically by monitoring any aspect of a user. In another embodiment, the modules/platforms 404-424 may provide the AD platform 402 with information in response to a user action or user interaction with the modules/platforms or any other entity. In another embodiment, the modules/platforms 404-424 may provide the AD platform 402 with information in response to receiving a request for information (e.g., a request from the AD platform 402, a request authorized by a user, etc.).

In one embodiment, the AD platform 402 may store the information received by the modules/platforms 404-424. In another embodiment, the AD platform 402 may associate the information received by the modules/platforms 404-424 with a user and/or a device. In another embodiment, the information sent by the modules/platforms 404-424 may be associated with a user and/or a device. For example, in one embodiment, the modules/platforms 404-424 may be associated with one or more applications. In this case, in one embodiment, instances of the applications (or the applications) may be associated with a user of a mobile device (e.g., utilizing a device ID, user login credentials, cookies, etc.). Accordingly, in one embodiment, the applications may share information that is associated with the user and/or the mobile device. In other embodiments, the information that is shared may be done so such that the user and/or mobile device remains anonymous using anonymous identifiers and/or encryption techniques.

In one embodiment, the AD platform 402 may utilize the information received to determine advertisements and/or content to present or provide to a user device (or initiate any action, for that matter). In another embodiment, the AD platform 402 may utilize the information received to determine advertisements and/or content to present or provide to a service, module, and/or application capable of presenting or providing the advertisements and/or content.

Further, in one embodiment, the AD platform 402 may be associated with (or may be integrated with) another application, such as a master application. In this case, in one embodiment, the AD platform 402 may provide content and/or advertisements for display in association with the master application. For example, in one embodiment, the master application may include a social network application. In this case, the AD platform 402 may utilize the information provided by feeder applications (e.g., the modules/platforms 404-424, etc.) to select and/or provide targeted advertisements to the master application. In one embodiment, the master application may include the AD platform 402. In another embodiment, the AD platform 402 may include a third party platform capable of providing or suggesting content/advertisements to the master application.

In various embodiments, the master application may include any application capable of receiving information from one or more feeder applications. For example, in various embodiments, the master application may include a social network application, a mobile wallet application, an online retailer/service provider application, a network browser application, an application associated with an operating system of a mobile device, and/or any other capable of receiving information from one or more feeder applications.

In one embodiment, a feeder application may be provided by a company along with a purchased product and/or service. In this case, in one embodiment, the provided feeder application may feed information to the master application (e.g., a social networking application, a mobile operating system, etc.). In one embodiment, the master application may drive advertisement/content presentation decisions, based on the provided information. In various embodiments, the feeder application may include a generic feeder application, a company specific feeder application, a product/service specific feeder application, an application with functionality that includes information feeding functionality, and/or various other applications.

In one embodiment, the master application may provide information to company advertisements and/or other relater and/or other related-third party advertisers to trigger advertisements. More information about providing dynamic advertisements may be found in U.S. Provisional Patent Application No. 61/590,764, filed Jan. 25, 2012, titled “SYSTEM, METHOD, AND COMPUTER PROGRAM PRODUCT FOR PRESENTING INFORMATION TO A USER BASED ON DETERMINED SATISFACTION-RELATED INFORMATION ASSOCIATED WITH THE USER,” which is incorporated herein by reference in its entirety.

The feeder applications may include any application capable of providing information to one or more other applications (e.g., master applications, etc.). For example, in various embodiments, the feeder applications may include one or more applications associated with a restaurant, a store (e.g., a grocery store, a clothing store, an online store, etc.), a social network, a mobile wallet, entertainment (e.g., a cinema, a stadium, a club, etc.), an inventory system, a Supply Chain Management system, a vehicle, a service, and/or any other application capable of providing information to a master application.

In one embodiment, a user of a mobile device may be prompted to download a feeder application. In one embodiment, a user may be prompted to download one or more applications based on a determined location of the user and/or the mobile device.

For example, in one embodiment, the location of the mobile device may be determined. Based on the determined location, the user may be prompted to download (or execute, etc.) an application relevant to the location. For example, the determined location may be determined to be near a retail store or establishment. Accordingly, an option to download an application associated with the retail store or establishment may be presented to the user on the mobile device.

In one embodiment, the feeder application may be configured to operate as a one-click download (and/or install, execute, etc.) and initiate in response to a wizard pop-up (e.g., in response to a location determination, etc.). In this way, users of mobile devices may be presented with the option to download feeder applications to feed one or more master applications. In one embodiment, a user may be presented an option to download a feeder application when the user enters a network (e.g., at or around the time the user is prompted to determine whether to connect to the network, after the user joins a network, etc.).

In one embodiment, after or before joining a wireless network, a user may be invited to download an application from a server (e.g., an application store) via the wireless network. In one embodiment, the application may include a feeder application associated with a business that may or may not own and/or manage the wireless network (e.g., the owner, etc.). In one embodiment, upon identifying a network (or entering a location, etc.) the user may be presented with an option to join the network (which may or may not be free).

In one embodiment, the aforementioned option to join the network may be presented simultaneously with a description of the network and/or an associated application available for download, and/or a link to an application store web site. In such embodiment, the network and application (or at least the application) may be identified/described together as a single option so that, upon selection of such option, multiple actions may be initiated (e.g., both joining of the network and downloading (and possibly execution, etc.) of the application, etc.).

In another embodiment, the network and application may be simultaneously identified and/or described as separate options so that, upon selection of a first network-related option, the network is jointed and, upon selection of a second application-related option, the application may be downloaded (and possibly executed). Of course, the execution may require a separate option selection, as well. In yet another embodiment, the option to join the network may be presented with a network description of the network first, and, only after joining, an associated application available for download and/or a link to an application store web site may be displayed thereafter.

As an option, the network description may describe the availability of the application (after the network has been joined). To accomplish this, in one embodiment, a “network name” may be expanded to describe the feeder application, so that, when the network name is presented to a user of a mobile device, the user understands that at least one purpose of such network connectivity is to download the feeder application. Further, after the network is joined, a browser application may or may not be automatically executed for displaying a predetermined hot-spot web page that includes feeder application description, download instructions (along with necessarily link(s), etc.) for downloading the feeder application. Of course, such web page may or may not include log-in functionality, as well as payment functionality, etc. In one embodiment, the mobile device (or OS thereof) may be configured to identify (or be notified of) the availability of the feeder application via the network connection and avoid the launch of the aforementioned browser by simply displaying one or more icons (similar to the one or more icons that prompted network connection), for downloading and/or executing the feeder application in response to a selection thereof.

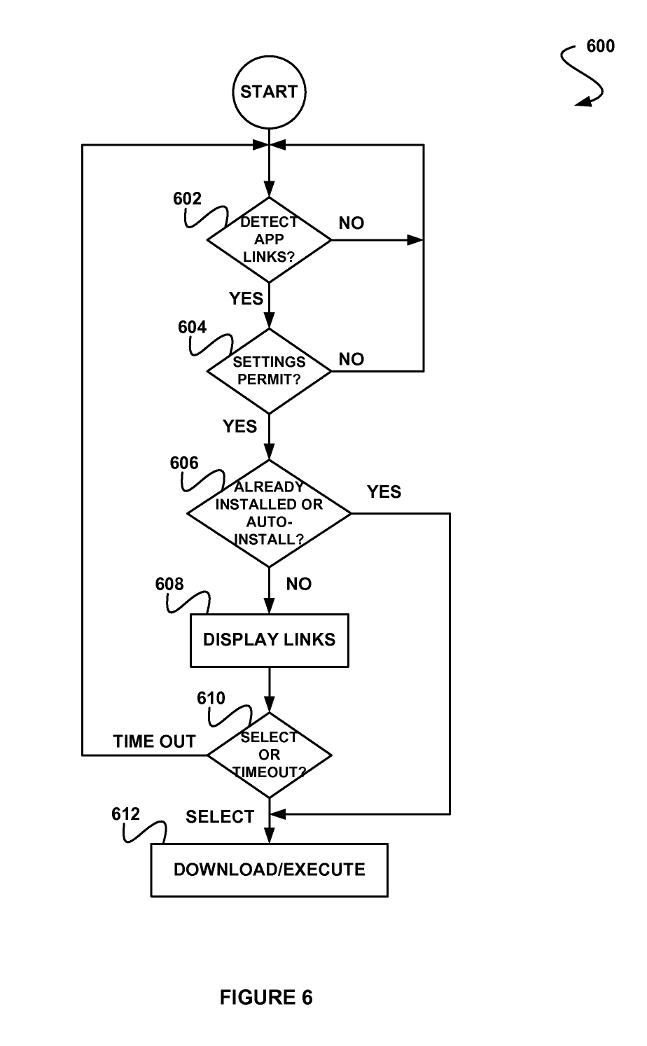

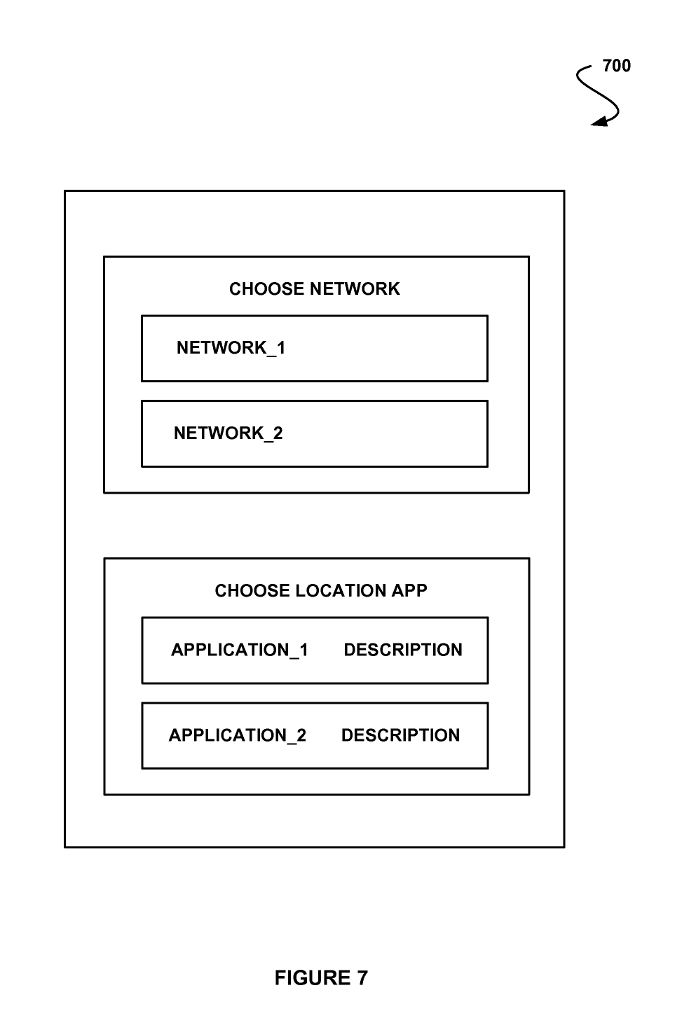

In one embodiment, the operating system associated with the mobile device may include an option (e.g., as part of a “Settings” menu, etc.) capable of indicating whether the aforementioned feeder application invitations are to be presented, and/or whether they can be automatically downloaded and/or executed. More information regarding various options that may or may not be utilized in connection with any of the above embodiments will be set forth during the description of FIGS. 6-7.

In another embodiment, feeder applications may be downloaded utilizing an associated website. In one embodiment, a user may access a website, launch a feeder application, download a feeder application, and/or otherwise implement functionality for providing a master application information, by first viewing or experiencing a product/service associated with a company via a magazine (digital or paper, etc.), television, newspaper, and/or other content.

For example, a user viewing a magazine may insert a code displayed in the magazine to initiate a feeder application. In one embodiment, the user may input the code into a website associated with a company, which the user accessed on a mobile device. In another embodiment, the user may insert the code as a text message (e.g., an SMS message, an MMS message, etc.). In one embodiment, in response to the text a link may be provided to download the feeder application. In one embodiment, a number to text the code may be provided along with the code.

In another embodiment, a user may utilize the application stored on the mobile device to capture an image associated with content (e.g., magazine content, television content, etc.). In one embodiment, utilizing information captured in the image, the application stored of the mobile device (or another application associated therewith, etc.) may determine a relevant feeder application, such that the user may access the feeder application, download the feeder application, and/or execute the feeder application, etc. In various embodiments, the information captured in the image may include a product/company name, a product/company logo, a product/company identifier, a bar code (e.g., a QR code, a UPC code, etc.), an alphanumeric or numeric code, and/or a product image, etc.

In another embodiment, one or more machines associated with a user may include feeder applications available for download to the mobile device associated with the user (e.g., via a Bluetooth connection, a wired connection [e.g., USB, etc.], a near field connection (NFC), a Wi-Fi connection, etc.). In various embodiments, the machines may include household appliances (e.g., a washing machine, a dryer, a refrigerator, a heating system, a cooling system, a thermostat, cooking devices [e.g., an oven, a stove, a cooking range, a microwave, a toaster, etc.], etc.), a coffee maker, an alarm clock, a security system, a vehicle, a vehicle computer, an entertainment system, a television, a set-top box, a web-based media set-top box, a computer, and/or various other machines.

In various embodiments, the feeder application stored on the machine may be capable of being downloaded to the mobile device of the user manually and/or automatically upon connection of the mobile device to the machine. In one embodiment, the mobile device operating system may include settings that establish whether automatic download of the feeder application is permitted. For example, in one embodiment, the user may be able to authorize automatic download of feeder application in the mobile device settings, when feeder applications are available. Further, in one embodiment, the user may have the ability to authorize automatic download of certain feeder applications (e.g., feeder applications associated with household appliances/machines, feeder applications associated with vehicles, feeder applications associated with locations, feeder applications associated with wireless networks, feeder applications associated with stores, feeder applications associated with restaurants, etc.).

In a situation where a product and/or service (with an associated feeder application) is purchased with a payment module (e.g., see 404), identified in search results provided by a search module (e.g., see 406), identified in a social network module (e.g., 422), etc.; an option may be given for downloading or otherwise accessing the feeder application. As yet another option, such downloading/access may be initiated automatically in connection with any of the above actions associated with the relevant modules (possibly as a function of download preferences, etc.).

In one embodiment, feeder applications associated with the machines may be able to output information from the mobile device to the machine. For example, in one embodiment, setting preferences may be determined and output from the mobile device of the user to the machine. Of course, in various embodiments, such communication may be implemented in a variety of ways, including a Bluetooth connection, a Wi-Fi connection, a near field connection, and/or a wired connection, etc.

In another embodiment, the operating system of the mobile device may include an interface and/or be associated with a connector application, such that information may be collected from other applications. For example, the interface associated with the operating system (or, in one embodiment, the operating system itself, etc.) may collect information from existing applications (e.g., media applications, email applications, browser applications, etc.) stored on the mobile device. In one embodiment, the information collected may be utilized by the AD platform 402 (which, in one embodiment, may be part of, or associated with, the operating system, etc.) to determine advertisements and/or content to be presented to the user on the mobile device.

In this way, an operating system of a mobile device, or an application associated therewith (e.g., a master application, etc.) may receive and/or collect information associated with one or more other applications, such that targeted advertisements and/or content may be selected and/or presented to a user on the mobile device. The information received and/or collected by the one or more other applications may include any information capable of being used to determine targeted advertisements and/or content, such as browsing history, social network information, a gender, an age, a birth date, an astrological sign, a nationality, a religion, a political affiliation (e.g., Democrat, Republican, etc.), a height, a weight, a hair color, an eye color, an ethnicity, a living address (e.g., a home address, etc.), a work address, an occupation (e.g., student, engineer, barista, unemployed, etc.), a sexual preference, an education level (e.g., a high school education, a college education, a postgraduate degree, etc.), a birth place, a school attended (e.g., an elementary school attended, a middle school attended, a high school attended, a college attended, etc.), an area once lived (e.g., during adolescence, after high school, during adult years, etc.), a relationship status (e.g., single, married, significant other, etc.), a family status (e.g., living parents, divorced parents, estranged from parents, etc.), a number of siblings, an income, a car (e.g., a car model, a car make, a car year, a car price, etc.), a number of children, hobbies (e.g., reading, running, volunteering, biking, golf, climbing, etc.), exercise habits (e.g., number of hours/minutes a week, number of times a month, type of exercise preferred, etc.), a number of pets owned, a type of pets owned (e.g., dogs, cats, fish, gerbils, etc.), food preferences (e.g., vegetarian, vegan, mainly meat, Chinese cuisine, Mexican cuisine, etc.), drinking habits (e.g., daily, weekly, monthly, etc.), eating habits (e.g., eat in, dine out, snacks, meals, etc.), TV watching preferences (e.g., types of preferred shows, number of hours/minutes per day/week, etc.), movie watching preferences (e.g., types of preferred movies, number of movies per day/week/month, etc.), music preferences (e.g., preferred genre, preferred artist, etc.), sleeping preferences (e.g., the number of hours of sleep preferred, the preferred bed time/rise time, etc.), moods (e.g., generally a good mood, generally a bad mood, etc.), feelings (e.g., generally happy, generally sad, generally angry, etc.), desires (e.g., goals, wishes, etc.), and/or any other personal information.

In various embodiments, the personal information may include permanent personal information (e.g., physical traits, history, etc.), temporal personal information (e.g., what the user is doing/feeling/experiencing now or within a predetermined window of time, etc.), and/or future goal-oriented personal information (e.g., wants, desires, etc.).

In one optional embodiment, the personal information may be received in association with a social networking site that allows users to define themselves in a profile (e.g., which may include any one or more of the personal information parameters disclosed hereinabove and/or herein below, etc.); associate themselves with others (e.g., friends, colleagues, other groups, etc.) by connecting to each other; and/or engage in activities (e.g., using applications such as games, reviewing content, sharing content (e.g., interests, thoughts, questions, media, etc.), etc.

In such embodiment, the personal information may be received from a social networking profile of the user associated with a social networking site. Further, the personal information may include any entities (e.g., people, groups, institutions, products, etc.) to which the user is associated (e.g., connected, subscribed, linked) during use of the social networking site. Such associations may also be extended to “associations-of-associations” (e.g., friends of friends, etc.). Even still, tracking such associations as personal information may be extended to a threshold number (e.g., 1, 2, 3, 4, 5, etc.) of degrees-of-separation. As a further option, the personal information may be received based on any of the aforementioned activity of the user in connection with the social networking site. In such example, any profiling metadata collected based on the activity of the user may be utilized as the personal information.

One optional embodiment is contemplated wherein an on-line application associated with the social networking site may collect and/or use the aforementioned social networking site-related personal information in connection with any of the functionality disclosed hereinabove and/or herein below. Of course, such social networking site-related on-line application may do so by itself and/or in connection with other one or more social networking site-related on-line application(s) or separate/independent site-related on-line application(s). To be clear, any of the above on-line application(s) may either be developed and/or purchased so as to be under the complete control of the social networking site, be separate from but hosted or controlled (at least in part via framing or similar technology) by the social networking site, and/or be complete separate from the social networking site, but exchange information therewith (via an interface, protocol, or download/export of information, etc.) to accomplish any one or more capabilities disclosed herein.

To this end, a pre-existing social networking site may be leveraged to accomplish any one or more of the operations disclosed herein. With that said, any site that collects any of the personal information disclosed herein may optionally be used in lieu of or in combination with the aforementioned social networking site. For example, an e-commerce site (e.g., product supply website, etc.) that collects profile information, etc. may be utilized in a similar manner.

More information regarding targeted advertisements and content may be found in U.S. Provisional Patent Application No. 61/563,741, filed Nov. 25, 2011, titled “SYSTEM, METHOD, AND COMPUTER PROGRAM PRODUCT FOR PRESENTING DECISION RELATED INFORMATION;” U.S. Provisional Patent Application No. 61/590,764, filed Jan. 25, 2012, titled “SYSTEM, METHOD, AND COMPUTER PROGRAM PRODUCT FOR PRESENTING INFORMATION TO A USER BASED ON DETERMINED SATISFACTION-RELATED INFORMATION ASSOCIATED WITH THE USER” U.S. Provisional Patent Application No. 61/591,819, filed Jan. 27, 2012, titled “SYSTEM, METHOD, AND COMPUTER PROGRAM PRODUCT FOR ALTERING AT LEAST ONE ASPECT OF AN INTEGRATED E-COMMERCE ON-LINE APPLICATION;” and U.S. Provisional Patent Application No. 61/596,174, filed Feb. 7, 2012, titled “SYSTEM, METHOD, AND COMPUTER PROGRAM PRODUCT FOR ALTERING AT LEAST ONE ASPECT OF AN INTEGRATED E-COMMERCE ON-LINE APPLICATION,” which are incorporated herein by reference in their entirety.

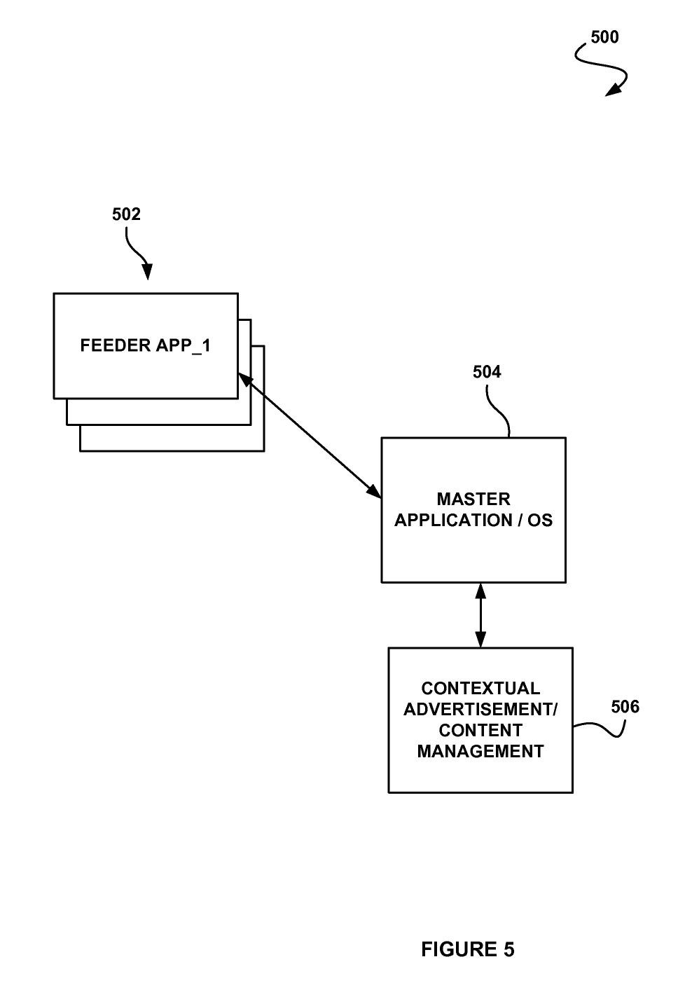

FIG. 5 shows a system 500 for contextual advertisement management in connection with a mobile device, in accordance with another embodiment. As an option, the system 500 may be implemented in the context of the architecture and environment of the previous Figures and/or any subsequent Figure(s). Of course, however, the system 500 may be implemented in the context of any desired environment. It should also be noted that the aforementioned definitions may apply during the present description.

As shown, one or more feeder applications 502 may be in communication with a master application or operating system 504. In one embodiment, the master application or operating system (OS) 504 may be in communication with one or more contextual advertisement/content management system 506, and/or may even be integrated therewith.

In operation, the feeder applications 502 may provide information to the master application/OS 504, such that the advertisements and/or content may be selected (again, or any action initiated), based on the information. In one embodiment, the advertisements and/or content may be displayed on a mobile device that is hosting the master application/OS 504. In one embodiment, the master application/OS 504 may select the advertisements and/or content to be displayed or presented. In another embodiment, the master application/OS 504 may provide information (e.g., the information from the feeder applications 502, additional information, etc.) to the advertisement/content management system 506, and the advertisement/content management system 506 may select the advertisements and/or content to be displayed or presented.

In one embodiment, the mobile device associated with the master application/OS 504 may also include the advertisement/content management system 506. In another embodiment, the advertisement/content management system 506 may be a networked based system (e.g., accessed over a network, etc.). Similarly, in one embodiment, the mobile device associated with the master application/OS 504 may include the feeder applications 502. In another embodiment, the feeder applications 502 may be networked based applications (e.g., accessed over a network, etc.).

In the context of the present description, a feeder application refers to any code capable of being used by an operating system and/or other application to receive and/or obtain information. Of course, such feeder application may be separate and/or integrated with (e.g., part of, etc.) of the operating system. In one embodiment, the information may include any information capable of being utilized to determine and/or select, and/or aid in the determination and/or selection of one or more advertisements and/or content. For example, in various embodiments, the feeder applications may include applications associated with a social network, retailers/service providers, household appliances, vehicles, browsers, cameras, text messages, emails, a mobile wallet, information gathering, GPS, mapping, location determining, products, real estate, music, movies, television, games, venues (e.g., stadiums, bars, restaurants, etc.), specific locations, libraries, and/or various other types of applications.

In one embodiment, the mobile device may be configured such that a master application receives the information from the feeder applications 502. In another embodiment, the mobile device may be configured such that the operating system receives the information from the feeder applications 502. In this case, in various embodiments, the mobile device may or may not include a master application.

The master application may include any application capable of receiving information from the feeder applications 502. In one embodiment, the master application may be associated with the operating system of the mobile device. In another embodiment, the master application may include a social network application. In another embodiment, the master application may include a finance related application (e.g., a mobile wallet application, etc.). In another embodiment, the master application may include a search engine application. In another embodiment, the application may include an advertisement application. In another embodiment, the application may include a decision making platform application. Further, in various embodiments, the master application may be stored on the mobile device and/or may include a networked application.

In one embodiment, the master application/operating system 504 may utilize the information received by the feeder applications 502 to select advertisements. In another embodiment, the master application/operating system 504 may send the information (or selected relevant information, etc.) to the contextual advertisement/context management system 506, such that the contextual advertisement/context management system 506 may select advertisements to be displayed on the mobile device and/or another device. Again, any action may be initiated.

In one embodiment, the contextual advertisement/context management system 506 may be associated with (e.g., part of, etc.) the master application/operating system 504. In another embodiment, the contextual advertisement/context management system 506 may be a system and/or application separate from the master application/operating system 504.

Any of the information provided from the feeder applications 502 may be utilized to determine/select advertisements/content to present to a user of the mobile device. For example, the information provided by the feeder applications 502 may include personal information capable of being used to target advertisements/content to a particular user of the mobile device. As another example, the information provided by the feeder applications 502 may include information corresponding to actions of the user capable of being used to target advertisements/content to a particular user of the mobile device.

As another example, the information provided by the feeder applications 502 may include purchase history information capable of being used to target advertisements/content to a particular user of the mobile device. As another example, the information provided by the feeder applications 502 may include demographic information capable of being used to target advertisements/content to a particular user of the mobile device. As another example, the information provided by the feeder applications 502 may include browsing information capable of being used to target advertisements/content to a particular user of the mobile device.

As another example, the information provided by the feeder applications 502 may include product/service interest information (e.g., social network “Like” information, etc.) capable of being used to target advertisements/content to a particular user of the mobile device. As another example, the information provided by the feeder applications 502 may include viewed product/service information capable of being used to target advertisements/content to a particular user of the mobile device. Of course, the information may include any information capable of being used to target advertisements/content to the user.

In various embodiments, the feeder applications 502 may be automatically pushed to the mobile device, automatically downloaded by the mobile device, manually downloaded to the mobile device, and/or executed by the mobile device at a remote location, etc. In one embodiment, one or more links to the application may be provided to the mobile device. For example, in one embodiment, the link may be provided to the mobile device in a text message. In another embodiment, the link may be provided to the mobile device in an email.

In another embodiment, the link may be provided by an application on the mobile device (e.g., an application store application, an application availability application, etc.). In one embodiment, if an application (or a link to an application, etc.) is available for execution and/or download, a notice may be provided to the mobile device.

FIG. 6 shows a system 600 for downloading/executing feeder applications in connection with a mobile device, in accordance with another embodiment. As an option, the system 600 may be implemented in the context of the architecture and environment of the previous Figures and/or any subsequent Figure(s) (e.g., see description of FIG. 4, for example). Of course, however, the system 600 may be implemented in the context of any desired environment. It should also be noted that the aforementioned definitions may apply during the present description.

As shown, a mobile device (or an application associated therewith, an OS associated therewith, etc.) determines whether one or more application links are detected. See determination 602. In one embodiment, the application links may include links, addresses, network locations, etc. associated with one more feeder applications capable of being executed and/or downloaded. In one embodiment, the detection of available application links may be automatic. In another embodiment, the detection of available application links may be manual (e.g., a user queries for available feeder applications, etc.). In another embodiment, an indicator may be displayed on the mobile device when applications are available.

In various embodiments, the links to the applications may include an html link, an indicator with an embedded link, an email including the link, a text message including the link, a link to a website including the application, and/or any other type of link. In various embodiments, the link to the application may include a link to download the application and/or upload the application.

If application links are detected, it is determined whether the mobile device settings permit installation, download, and/or execution of the application. See determination 604. In one embodiment, a user of the mobile device may have the ability to authorize access (e.g., download, execution, installation, etc.) to the application utilizing the mobile device. In another embodiment, the user may have the ability to authorize access (e.g., download, execution, installation, etc.) to specific applications and/or certain types of applications. In one embodiment, applications available for download, etc. may be presented to the user on the mobile device, such that the user may select the applications to download, etc. In another embodiment, the settings may present the user with a list of different types of applications and the user may have the ability to select the types of applications to access. In another embodiment, suspicion applications and/or application links may be flagged, such that the user is required to acknowledge or permit access before access to the application is permitted.

If the settings associated with the mobile device permit download, execution, and/or installation of the application associated with the link, it is determined whether the application is already installed and/or whether auto-install is permitted. See decision 606. In one embodiment, the user may have the ability to authorize automatic installation of feeder applications in the settings associated with the mobile device.

If it is determined that the application is already installed or is to be automatically installed, the application is downloaded if necessary, and the application is executed. See operation 612. In one embodiment, the user may be required to authorize the download and/or installation of the application (e.g., with a one-click option, etc.). Additionally, in one embodiment, the user may be required to select the application (or an icon associated therewith, etc.) to execute the application.

If it is determined that the application is not already installed or automatic installation is not enabled, link(s) to the available application(s) are displayed. See operation 608. In various embodiments, the links to the applications may be displayed as an html link, an indicator (e.g., an image, an icon, an application name, etc.) with an embedded link, an email including the link, a text message including the link, a link to a website including the application, a list, and/or any other type of link.

In one embodiment, a description associated with the application may be provided. In one embodiment, the description of the application may be displayed along with the link (or access to the link, etc.). In another embodiment, the description of the application may be displayed upon a selection by the user (e.g., a selection of a drop-down description icon, etc.).

Once the links to the available applications are displayed, it is determined whether the user has selected one or more links or whether there is a timeout. See determination 610. In one embodiment, a timeout may not be present. If a selection has been made, the application(s) corresponding to the link(s) are downloaded and/or executed. See operation 612.

FIG. 7 shows a mobile device interface 700 for downloading/executing feeder applications in connection with a mobile device, in accordance with another embodiment. As an option, the interface 700 may be implemented in the context of the architecture and environment of the previous Figures and/or any subsequent Figure(s) (e.g., see description of FIG. 4, for example). Of course, however, the interface 700 may be implemented in the context of any desired environment. It should also be noted that the aforementioned definitions may apply during the present description.

As shown, the interface 700 may be utilized to present a user of a mobile device options to join one or more networks (e.g., wireless networks, etc.). Additionally, the interface 700 may present the user an option to download and/or execute one or more location specific (or location relevant, etc.) feeder applications. For example, in one embodiment, when a mobile device is exposed to a wireless network (e.g., a Wi-Fi network, etc.), feeder applications associated with that network may be presented for download or execution utilizing the interface 700. The networks may be associated with businesses, venues, cities, vehicles, and/or various other entities.

It should be noted that, in various embodiments, the network-related icons and application-related icons may be displayed on the same interface (e.g., simultaneously, etc.) or in sequence. For example, the network-related icons may be displayed first and, after selection thereof, the application-related icons may subsequently be displayed thereafter (if applicable for the network joined), as described earlier. In other embodiments, only the application-related icons may be displayed (e.g., such that joining a network is implied/inherent/combined) without requiring separate joining of a network.

In one embodiment, the mobile device may present an alert when networks and/or applications are available. In various embodiments, the alert may include a pop-up, an audible alert, an indicator, an icon, a message, and/or any other type of alert. In another embodiment, the interface 700 may be presented to the user on the mobile device when new applications and/or networks are available. In still another embodiment, the mobile device may present an alert in response to removing the mobile device from a standby mode. In such embodiment, the alert (and/or any of the icons disclosed hereinabove) may be displayed in a connection with (e.g., simultaneously with, immediately before or after, etc.) the display of a lock/password protection screen (e.g., for example, in the context of the lock/password protection screen display techniques disclosed herein in association with subsequent figures, etc.).

The applications may include any type of application. For example, in various embodiments, the applications may include applications associated with games, learning, photos, calendar, routing, maps, music, social networking, movies, VOIP, retailers, venues, any application that performs, causes, or facilitates the aforementioned action(s), etc. In one embodiment, the applications may provide information to an OS associated with the mobile device, an application associated with the mobile device, and/or an advertisement/content management system such that targeted advertisements and/or content may be provided to the user.

The applications may provide any type of information, including demographics, psychographics, behavioral variables (e.g., product purchase history, etc.), user preferences, other second-order activities, and/or other information. In one embodiment, the information may be utilized in connection with one or more advertisement selection algorithms. In various embodiments, the advertisement selection algorithms may be implemented by the operating system of the mobile device, an advertisement management system, an application, and/or any other system capable of selecting advertisements based on provided information.

In one embodiment, the advertisements and/or content selected may be automatically presented to a user (e.g., on the mobile device, a vehicle display, etc.). In another embodiment, the user may have the ability to request targeted content and/or advertisements. In one embodiment, an application on the mobile device may operate to present targeted advertisements to the user. As an option, the user may view the targeted advertisements in list format.

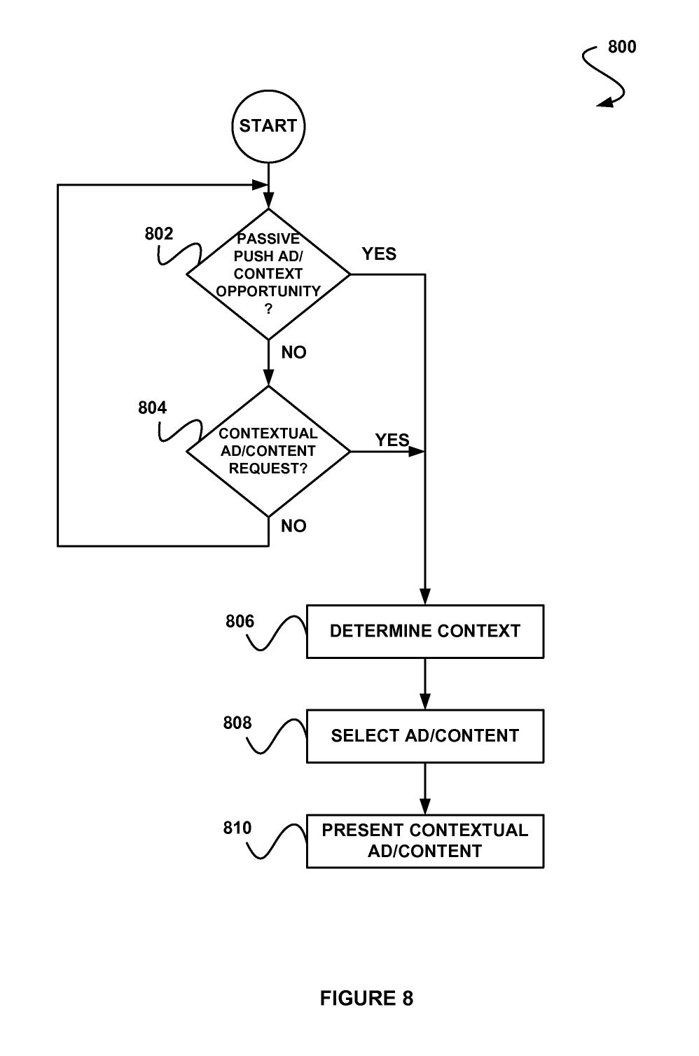

FIG. 8 shows a method 800 for presenting contextual advertisements, in connection with a mobile device, in accordance with another embodiment. As an option, the method 800 may be implemented in the context of the architecture and environment of the previous Figures and/or any subsequent Figure(s). Of course, however, the method 800 may be implemented in the context of any desired environment. It should also be noted that the aforementioned definitions may apply during the present description.

As shown, an advertisement/content management system (or software/a device associated therewith) determines whether an opportunity to passively push a targeted advertisement or targeted content exists. See determination 802. In one embodiment, an operating system or application associated with a mobile device may determine whether an opportunity to passively push a targeted advertisement or targeted content exists. In various embodiments, the determination whether to passively push the advertisement/content may be based on a current user activity, a current device mode (e.g., standby mode, active mode, etc.), current application usage, current location, a current mobile device screen status, a movement of the mobile device (or lack of movement, etc.), a physical orientation of the mobile device (e.g., vertical, horizontal, etc.), a connection status of the mobile device (e.g., connected via Bluetooth, etc.), whether the user is viewing the mobile device screen (e.g., determined utilizing a camera associated with the mobile device, etc.), and/or based on various other criteria.

Furthermore, it may be determined whether a contextual advertisement and/or content request is received. See determination 804. In one embodiment, the user of the mobile device may send the request for the contextual advertisement and/or content request. In one embodiment, the request may be initiated utilizing an application on the mobile device. As an option, a user may initiate the request by launching the application (e.g., by selecting an icon associated with the application, etc.).

In another embodiment, an application associated with the mobile device may request the advertisement and/or content. For example, an application being utilized by the user and/or by the mobile device may request the advertisement and/or content. If it is determined to present an advertisement and/or content, a context associated with the advertisement is determined. See operation 806.

In one embodiment, the context may be determined based, at least on part, on information provided by one or more feeder applications. In another embodiment, the context may be determined based, at least in part, on current and/or past activities of the user (e.g., as determined by hardware/software associated with the mobile device, etc.). In another embodiment, the context may be determined by current and/or past activities of the mobile device. In another embodiment, the context may be determined based on a location of the user and/or the mobile device. In various embodiments, the context may be determined by software associated with the mobile device, an advertisement/content management platform, an application, an operating system associated with the mobile device, and/or various other systems.

The context may include any circumstances that form the setting for an event (e.g., an advertisement display, a content display, etc.). For example, in various embodiments, information for determining the context may include location information (e.g., GPS location information, a physical address, an IP address, shopping center, movie theatre, stadium, etc.), network information (e.g., information associated with the network currently being utilized or currently being accessed, etc.), applications being utilized (e.g., games, maps, camera, retailer, social networking, etc. current activities (e.g., shopping, walking, eating, reading, driving, etc.), browsing activity, environment (e.g., environmental audio, weather, temperature, etc.), payment activities (e.g., just purchased coffee, groceries, clothes, etc. and/or any other type of information.

Once a context is determined, one or more advertisements and/or content are selected based, at least in part, on the determined context. See operation 808. In one embodiment, information associated with the user of the mobile device and/or information associated with the activities of the user may be utilized to select the advertisement(s)/content. In one embodiment, the additional information may be information received by feeder applications. Further, in one embodiment, the information may be received by a social network application (and/or social network system, etc.). In another embodiment, the information may be received by a mobile wallet application. In another embodiment, the information may be received by a retailer application.

In one embodiment, one or more advertisement/content selection algorithms may be utilized to select the content/advertisements. Once the advertisement (s)/content or content are selected, the contextual advertisement/content is presented. See operation 810. In various embodiments, the advertisement/content may be presented on the mobile device, and/or on another device capable of being viewer by the user. In various embodiments, the other device capable of being viewed by the user may include a television, a store display, a billboard, a vehicle display, a computer display, an e-reader display, and/or various other devices capable of displaying the advertisement/content.

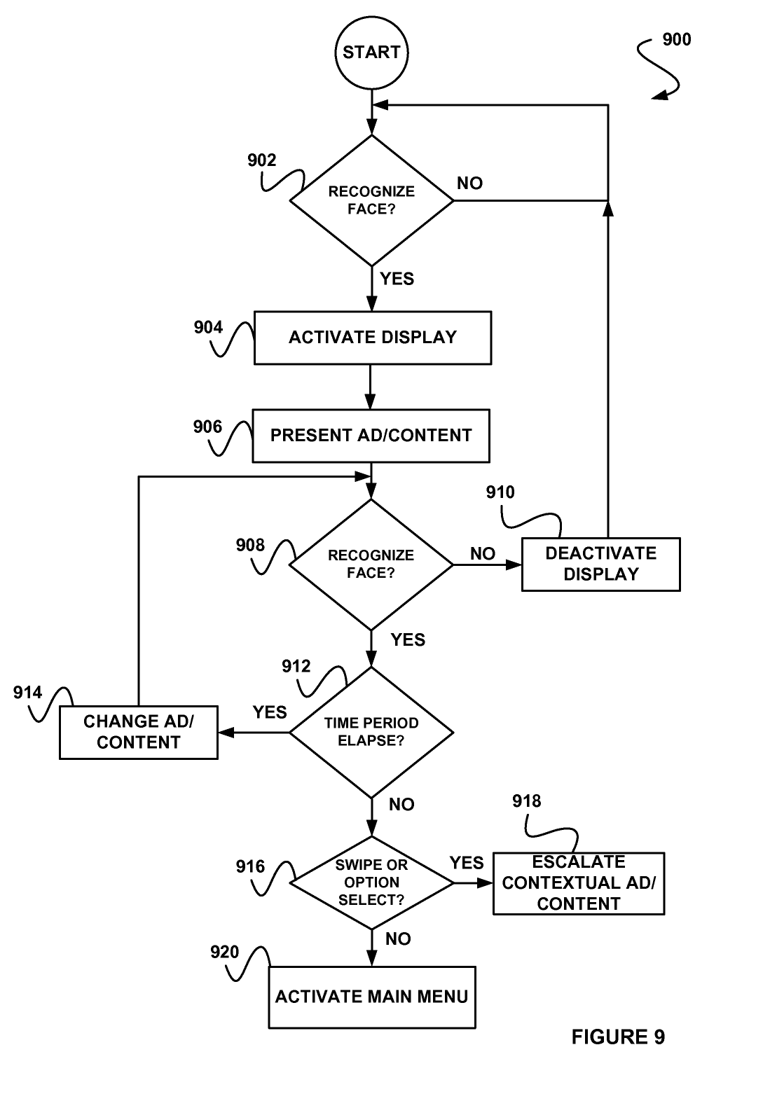

FIG. 9 shows a method 900 for presenting contextual advertisements, in connection with a mobile device, in accordance with another embodiment. As an option, the method 900 may be implemented in the context of the architecture and environment of the previous Figures and/or any subsequent Figure(s). Of course, however, the method 900 may be implemented in the context of any desired environment. It should also be noted that the aforementioned definitions may apply during the present description.

As shown, a mobile device (and/or hardware and/or software associated therewith, etc.) determines whether a face of a user is recognized. See determination 902. For example, in one embodiment, one or more cameras associated with the mobile device may capture one or more images capable of being utilized to perform one or facial recognition techniques to determine whether a face associated with the image(s) is recognized and/or authorized.

More information regarding facial recognition may be found in U.S. Provisional Patent Application No. 61/612,960, filed Mar. 19, 2012, titled “SYSTEM, METHOD, AND COMPUTER PROGRAM PRODUCT FOR ALTERING AT LEAST ONE ASPECT OF AN EXPERIENCE OF A VIEWER IN ASSOCIATION WITH A TELEVISION,” which is incorporated herein by reference in its entirety.

In one embodiment, the camera(s) associated with mobile device may capture the one or more images in response to motion. Additionally, in one embodiment, the camera(s) may capture the one or more images in response to a change in a mode of the mobile device (e.g., a change from standby to on, etc.). In another embodiment, the camera(s) may capture the one or more images in response to an instruction from an application. In another embodiment, the camera(s) may capture the one or more images in response to a user action associated with the mobile device. In various embodiments, the user action may include an audible utterance detected by the mobile device, a motion detected by the mobile device (e.g., a hand motion, a finger motion, etc.), a button press, a touch of a screen of the mobile device, and/or various other actions.

In another embodiment, the camera(s) associated with the mobile device may periodically capture images (e.g., at user adjustable time intervals, etc.). In another embodiment, a sensor may be utilized to detect the presence of a user and the camera may capture images. In another embodiment, the camera may be utilized to sense the presence of a user. In one embodiment, a camera application and/or a facial recognition application may operate in the background. For example, in one embodiment, the camera application and/or the facial recognition application may operate in a standby mode of the mobile device.

In one embodiment, the camera may record images of objects in its field of view. In various embodiments, the camera may be configured to record images periodically (e.g., a fixed rate, etc.), in response to movement within a zone in front of the camera (e.g., in response to a user moving into position in front of the camera, etc.), in response to explicit input from a user (e.g., a user touching a key or screen of the mobile, etc.). In one embodiment, the camera may be configured to record images at a low rate when activity is not detected within a zone in front of the camera and to record images at a higher rate when activity is detected within the zone. This may allow the camera to respond quickly to a user beginning to use the mobile device or to a user who stops using the mobile device, thereby avoiding consuming resources at a high rate. In some implementations, the images recorded may be discarded after a threshold amount of time has elapsed since the images were recorded (e.g., 1 minute, 2 minutes-5 minutes, etc.). Further, in one embodiment, the images recorded may be discarded when the mobile device is shut down or enters a low-power state.

In one embodiment, the images recorded may be received and analyzed by a user recognizer application (or software, etc.) to determine an identity of the user whose image is recorded. In various embodiments, the user recognizer may perform facial recognition on the images. For example, the user recognizer may compare the facial features of the user, as detected by the camera and analyzed by the user recognizer with the facial features of one or more potential users. The comparison may include a comparison of other facial features that can be used to identify a user.

Various facial recognition techniques can be used. For example, in one embodiment, techniques may be used that distinguish a face from other features in the field of view of the camera and subsequently measure the various features of the face. Every face has numerous, distinguishable landmarks, and different peaks and valleys that make up facial features. In one embodiment, these landmarks may be used to define a plurality of nodal points on a face, which may include information about the distance between eyes of a user, the width of the nose of the user, the depth of eye sockets of the user, the shape of the cheekbones of the user, and/or the jaw line length of the user, etc. In one embodiment, the nodal points of the face of the user may be determined from one or more images of the face of the user to create a numerical code (i.e., a faceprint, etc.) representing the face of the user.

In another embodiment, facial recognition may be performed based on three-dimensional images of the face of the user or based on a plurality of two-dimensional images which, together, may provide three-dimensional information about the user's face. Three-dimensional facial recognition uses distinctive features of the face, e.g., where rigid tissue and bone is most apparent, such as the curves of the eye socket, nose and chin, to identify the user and to generate a faceprint of the user. The faceprint of a user may include quantifiable data such as a set of numbers that represent the features on a user's face.

In another embodiment, a plurality of two-dimensional images of different points of view relative to the face of the user may be obtained and used to identify the user. This also may foil attempts to fool the facial recognition technology, such as by holding up a photograph of a user who is not actually present in front of the mobile.

After an identity of the user has been determined based on one or more images of the user (e.g., determined through a quantifiable faceprint that is generated of the user's face, etc.), the user recognizer software may compare the identity of the user to one or more predetermined identities. In one embodiment, if a match is found between the determined identity and a predetermined identity, the display of the mobile device may be activated. See operation 904. In one embodiment, the user may be logged into the mobile device if a match is found.

In one embodiment, the predetermined identities may be stored by the mobile device, for example, in one or more memories. In another embodiment, the predetermined identities may be stored on a networked server or database. In various embodiments, the predetermined identities may include one or more images of users, quantifiable face print information of one or more users, or a subset of quantifiable face print information, wherein the subset is insufficient to reconstruct an image of the user.

In one embodiment, the predetermined identities may be stored at the request of a user according to an opt-in process, for a user who wishes to take advantage of the facial recognition technology to log on to the mobile device. For example, in one embodiment, a default login procedure for a user may require the user to enter a first and second alphanumeric string, such as a username and a password. However, once the user has successfully logged in using a default login procedure the user may opt to have the mobile device store a predetermined identity associated with the user, so that during future logins the user make take advantage of a login procedure that is based on facial recognition technology, which may be less time consuming and less obtrusive to the user than entering a username and a password.

More information about facial recognition may be found in U.S. Pat. No. 8,261,090, issued Sep. 4, 2012, titled “Login to a computing device based on facial recognition,” which is incorporated herein by reference in its entirety.

Once the display of the mobile device is activated, a selected advertisement and/or selected content is presented to the user. See operation 906. In one embodiment, the selected advertisement/content may be targeted, as described in the context of the previous figures.

In one embodiment, the advertisement/content may be presented on a display screen associated with mobile device. In one embodiment, the advertisement/content may be presented on a lock screen associated with mobile device. Further, in one embodiment, the advertisement/content may be presented on a home screen associated with mobile device. In another embodiment, the advertisement/content may be presented on a main operating system screen associated with mobile device. In another embodiment, the advertisement/content may be presented by an application associated with mobile device. In another embodiment, the advertisement/content may be presented as a banner. In another embodiment, the advertisement/content may be presented on open space associated with the display (e.g., space not displaying applications icons, etc.). In another embodiment, the advertisement/content may be presented as open a pop-up.

Once the advertisement/content is presented, is it further determined whether the face viewing the advertisement is still recognized. See determination 908. If the face is not recognized, or there is not a user viewing the display, the display is deactivated. See operation 910. In one embodiment, the display may be placed in a standby mode. In another embodiment, the display may display an indicator that the current viewer in unauthorized. In another embodiment, the display may not be illuminated.

If the face is recognized, it is determined whether a time period of displaying the advertisement has elapsed. See determination 912. In one embodiment, the time period may include a predefined time period. In one embodiment, the time period may be associated with a screen illumination time period associated with the mobile device. In another embodiment, the time period may be associated with a fee paid by the advertiser.

If it is determined that the time period has elapsed, the advertisement/content is changed. See operation 914. In one embodiment, the advertisement may include another targeted advertisement/content.

If the time period has not elapsed, it is determined whether a swipe or option select of the advertisement/content is received. See determination 916. For example, in one embodiment, the user may click on the displayed advertisement to select the advertisement.

In another embodiment, the user may initiate a swipe with a finger across the advertisement/content and/or the screen to select the advertisement. In another embodiment, the advertisement/content may be selected by the user utilizing an audible utterance. In another embodiment, the advertisement/content may be selected based on a length of time of a gaze of the user. For example, the camera may capture images of the user viewing the advertisement/content. If the user views the advertisement/content for amount of time that exceeds a predefined threshold (e.g., 5 seconds, 10 seconds, 15 seconds, etc.), it may be determined that the advertisement/content has been accepted. Of course, the advertisement/content may be selected utilizing a variety of other techniques.

If it is determined that the advertisement/content has been selected, the contextual advertisement/content is escalated. See operation 918. The contextual advertisement/content may be escalated utilizing a variety of techniques. For example, in one embodiment, an advertisement/content with more detail/information associated with the original advertisement/content may be displayed. In another embodiment, the user may be routed to a website associated with the advertisement/content. In another embodiment, the user may be presented with an opportunity to purchase a product or service associated with the advertisement/content.

In another embodiment, the user may be presented with additional information associated with the advertisement/content. In another embodiment, the user may be presented with directions and/or a map to a location associated with the advertisement/content. In another embodiment, the user may be provided with coupons and/or discounts, on the mobile device. In another embodiment, the user may be offered the opportunity to share the advertisement/content. In various embodiments, the user may be offered the opportunity to share the advertisement/content on a social networking website, via a text message, via an email, via an audio message, by sending the advertisement/content to another mobile device/user, by posting the advertisement/content on a media board (e.g., a web page, etc.).

In still another embodiment, the user may presented with a menu with other available content and/or associated functionality. For example, if the initial ad/content of operation 906 is presented as a function of arriving at a particular location (and possibly at a particular time), such initial ad/content may include an ad/content that has some utilitarian purpose (e.g., boarding pass, entrance ticket, loyalty deal, etc.). Further, at least one possible option/selection made available in connection with such initial ad/content may be a display of a menu of ad/content and/or functionalities/services, etc. that are available via the application (e.g., feeder application, etc.) that prompted the display of the initial ad/content (e.g., via a master application/OS, etc.).

In one embodiment, the advertisement/content may be escalated on a device other than the original mobile device of a user. For example, in various embodiments, the advertisement/content may be escalated on a tablet computer, another mobile device, a third party display, a vehicle display, and/or any other type of display. For example, the user may select the advertisement/content on a mobile phone while shopping in a store (or lounging at a bar, etc.) and the advertisement/content may be escalated to a display in the bar. In one embodiment, communication between the mobile device and the display may be coordinated upon a check-in procedure undertaken by the user.

More information regarding user check-in may be found in U.S. Provisional Patent Application No. 61/590,767, filed Jan. 25, 2012, and titled “SYSTEM, METHOD AND COMPUTER PROGRAM PRODUCT FOR LOCATION-SPECIFIC PRIVACY SETTINGS,” which is incorporated herein by reference in its entirety.

If it is determined that the user did not select the advertisement/content, a main menu or screen associated with the mobile device is activated. See operation 920. In one embodiment, the advertisement/content may be removed when the main menu/screen is activated. Additionally, in one embodiment, activating the may screen may require user login (e.g., by entering a pass code, by facial recognition, etc.). The main menu/screen may include any main menu associated with the mobile device.

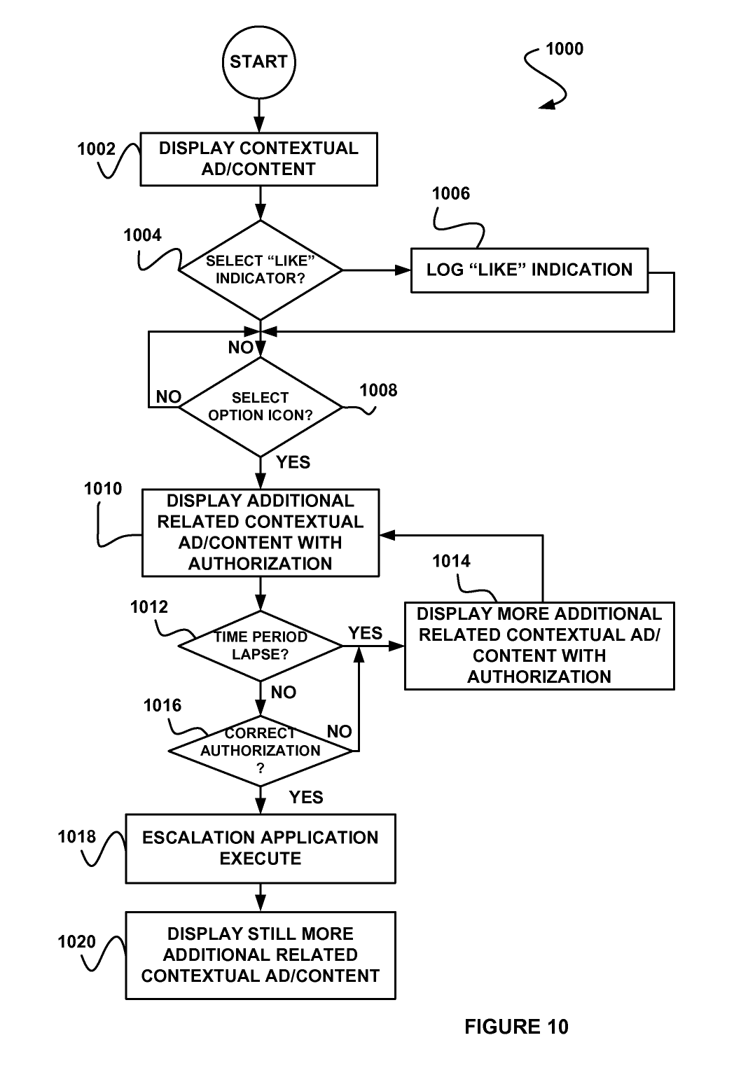

FIG. 10 shows a method 1000 for presenting contextual advertisements, in connection with a mobile device, in accordance with another embodiment. As an option, the method 1000 may be implemented in the context of the architecture and environment of the previous Figures and/or any subsequent Figure(s). Of course, however, the method 1000 may be implemented in the context of any desired environment. It should also be noted that the aforementioned definitions may apply during the present description.

As shown, a contextual advertisement or content is displayed. See operation 1002. In one embodiment, the contextual advertisement/content may be displayed on a screen of a mobile device associated with a user. In another embodiment, the contextual advertisement/content may be displayed on a television. In other embodiments, the contextual advertisement/content may be displayed on any other type of display.

Once the advertisement/content is displayed, it is determined whether the user selects a “Like” indicator associated with the advertisement/content. See determination 1004. In various embodiments, the “Like” indicator may include a graphical indicator (e.g., a thumbs up, a happy face, etc.), a text indicator (e.g., the word “Like,” etc.), a numerical indicator (e.g., a numerical rating, a 1-5 rating, etc.), and/or any other type of indicator. In one embodiment, the “Like” indicator may be presented along with the advertisement/content. In another embodiment, the “Like” indicator may be presented when a menu of options is selected.

If the “Like” indicator is selected, the “Like” indication is logged. See operation 1006. In one embodiment, the mobile device may log the “Like” indication. In another embodiment, a system associated with a social network may log the “Like” indication. In another embodiment, an advertisement system may log the “Like” indication. In one embodiment, the like indication may be logged in a networked database.

Further, it is determined whether an option icon is selected by the user. See determination 1008. In one embodiment, the option icon may include an arrow. In another embodiment, the option icon may include text (e.g., “Options,” “Additional Information,” “More,” etc.). In various embodiments, the option icon may include any type of image, character, and/or object.

If the option icon is selected, additional related contextual advertisements/content is displayed. See operation 1010. In one embodiment, the additional related contextual advertisement/content may only be displayed when authorization is provided. For example, in one embodiment, a password may be required to display the additional related contextual advertisement/content. In another embodiment, facial recognition may be used as authorization to display the additional related contextual advertisement/content. In another embodiment, biometric data (e.g., a finger print, thumb print, etc.) may be utilized as authorization.

The additional related advertisement/content may include any related advertisement/content. For example, in one embodiment, additional related advertisement/content may include additional information associated with the advertisement/content. In another embodiment, the additional related advertisement/content may include different related advertisements and/or content. In another embodiment, the additional related advertisement/content may include discounts associated with the advertisement/content. In another embodiment, the additional related advertisement/content may include barcodes associated with the advertisement/content. In another embodiment, the additional related advertisement/content may include discount codes associated with the advertisement/content.

Further, in one embodiment, the additional related advertisement/content may be selected utilizing user-related information. In another embodiment, the additional related advertisement/content may be selected utilizing user-related information that is different from user-related information utilized to select the original displayed contextual advertisement/content.

Further, it is determined whether a time period for displaying the additional advertisement has lapsed. See determination 1012. If the time period for displaying the advertisement has expired, more additional related contextual advertisements/content may be displayed. See operation 1014. In one embodiment, the more additional related contextual advertisement/content may only be displayed when authorization is provided. For example, in one embodiment, a password may be required to display the additional related contextual advertisement/content. In another embodiment, facial recognition may be used as authorization to display the additional related contextual advertisement/content. In another embodiment, biometric data (e.g., a finger print, thumb print, etc.) may be utilized as authorization. Of course, any additional related and/or unrelated ad/content and/or functionalities/services may be provided (e.g., see, for example, the description provided in connection with operation 918 of FIG. 9, etc.).

In one embodiment, it may be determined whether the authorization provided by the user matches correct authorization credentials. See determination 1016. If it is determined that the authorization is correct, an escalation application is executed. See operation 1018. The escalation application may include any application capable of escalating an advertisement/content. In one embodiment, the escalation may include displaying personalized advertising, content, and/or information. Upon execution of the escalation application, still more additional related contextual advertisement/content is displayed. See operation 1020. Of course, any additional related and/or unrelated ad/content and/or functionalities/services may be provided in connection with operation 1020 (e.g., see, for example, the description provided in connection with operation 918 of FIG. 9, operation 1014 of FIG. 10, etc.).

In one embodiment, prior to the user being authorized on a mobile device, the contextual advertisement/content may be displayed on a main screen associated with a device. In another embodiment, prior to the user being authorized on a mobile device, the contextual advertisement/content may be displayed on a lock screen associated with a device.

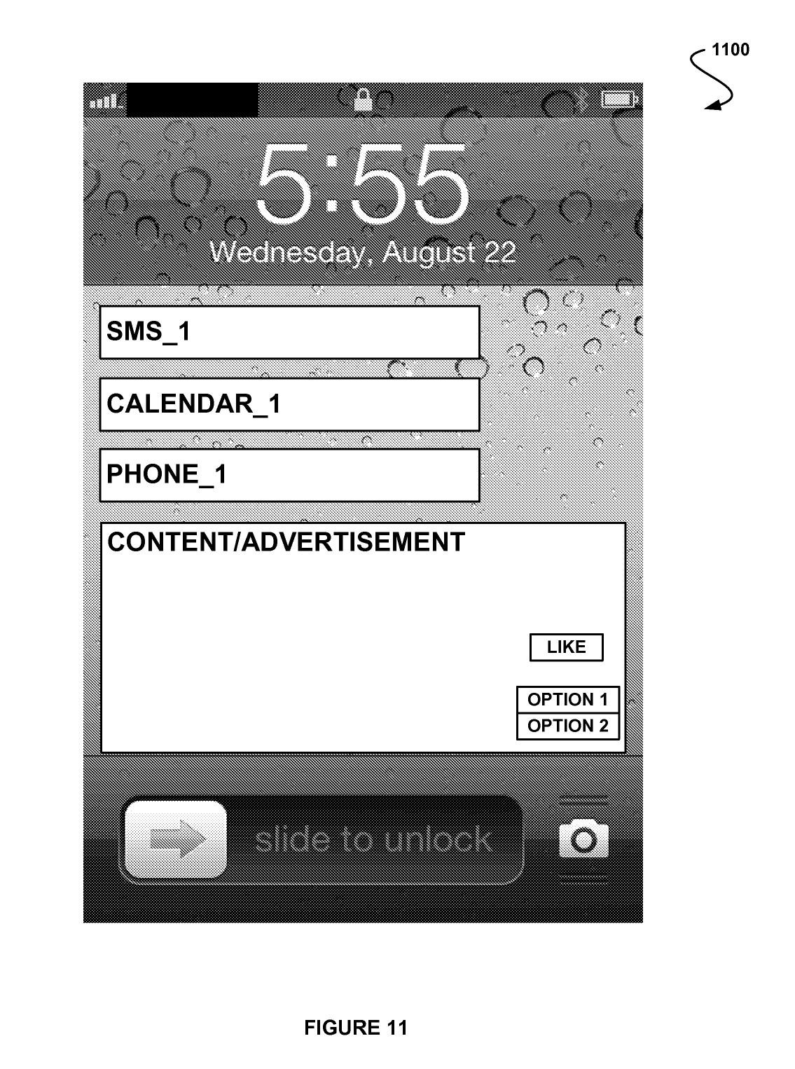

FIG. 11 shows a mobile device interface 1100 for displaying advertisements/content, in accordance with another embodiment. As an option, the interface 1100 may be implemented in the context of the architecture and environment of the previous Figures and/or any subsequent Figure(s). Of course, however, the interface 1100 may be implemented in the context of any desired environment. It should also be noted that the aforementioned definitions may apply during the present description.

As shown, the interface 1100 may be capable of displaying one or more alerts, as well as advertisements/content. In one embodiment, the interface 1100 may include a standby screen associated with the mobile device. In another embodiment, the interface 1100 may include a lock screen associated with the mobile device. In one embodiment, the interface 1100 may include an interface that is displayed prior to the user providing login or verification credentials (e.g., a password, facial verification, biometric verification, etc.).

In one embodiment, the interface 1100 may display a tier one contextual advertisement/content. In one embodiment, the tier one contextual advertisement/content may include an upper level more general targeted advertisement/content. In one embodiment, upon providing proper credentials (e.g., a password, biometrics, etc.), the advertisement may be escalated and a tier two advertisement/content may be displayed. In one embodiment, the tier two advertisement/content may include more targeted information than a tier one advertisement. Additionally, in one embodiment, the tier two advertisement/content may include more personalized information than a tier one advertisement.

In various embodiments, the interface 1100 may display text messages, calendar alerts, missed call alerts, voice message alerts, contextual advertisements/content, application availability alerts, and/or various other alerts. For example, in one embodiment, an advertisement may be selected based on information associated with the user (e.g., current location, current activity, purchase history, social network information, etc.). Upon determination of an optimal time to display the advertisement (e.g., based on current location, current activity, facial recognition, etc.), the advertisement may be displayed utilizing the interface 1100.

In one embodiment, options associated with the advertisement/content may be presented with the advertisement/content. For example, in one embodiment, the content/advertisement may be presented with an option to indicate a “Like” of the content/advertisement. In one embodiment, selecting a “Like” of the advertisement/content may cause an escalation of the content/advertisement. In another embodiment, selecting a “Like” of advertisement/content may cause an indication of the “Like” being stored in a database (e.g., a database associated with an advertiser, a database associated with a social network, etc.). In another embodiment, selecting a “Like” may cause the advertisement/content to be shared with other users. In various embodiments, the advertisement/content may be shared with other users via a post to a social networking site, a text message, an email message, via an application on a device associated with the other users (e.g., mobile phones, tablet computers, etc.), and/or utilizing various other techniques.

Further, in one embodiment, the content/advertisement may be displayed with one or more user selectable options. In one embodiment, the options may include escalating the advertisement/content. In one embodiment, escalating the advertisement/content may include providing more detailed information associated with the content/advertisement. In another embodiment, escalating the advertisement/content may include providing purchase options associated with advertisement content. In another embodiment, escalating the advertisement/content may include providing location information associated with the content/advertisement.

In another embodiment, the options may include displaying similar types of advertisements/content. In another embodiment, the options may include sharing the content/advertisement with one or more other users. In another embodiment, the options may include initiating a purchase of a product/service associated with the advertisement/content. In another embodiment, the options may include requesting additional information associated with the advertisement/content. In another embodiment, the options may include calling a number associated with the advertisement/content.

In another embodiment, the options may include sending a text message or email associated with the advertisement/content (e.g., to a company contact, etc.). In another embodiment, the options may include providing directions and/or a map associated with the advertisement/content. In another embodiment, the options may include removing the display. In another embodiment, the options may include displaying another unrelated advertisement. In one embodiment, upon entering a proper passcode at an initial display/screen, the advertisement/content may be escalated. Additionally, in one embodiment, upon entering an improper passcode at an initial screen, additional content/advertisements may be displayed. In one embodiment, the additional content/advertisements may include related content/advertisements.

As an option, the content/advertisement shown may be the first of a plurality of available content/advertisement that is appropriate (e.g., triggered) based on the current context (e.g., location, time, other parameters/criteria disclosed earlier, etc.). Such additional available content/advertisement may, in one embodiment be listed on top or bottom (or otherwise simultaneously) of the illustrated content/advertisement. In other embodiments, an icon may be provided for displaying the additional available content/advertisement upon the selection thereof. In other embodiments, a user may carry out a horizontal (or vertical) swipe gesture for triggering the display of an initially hidden additional available content/advertisement by replacing the current available content/advertisement. Of course, this may be repeated as many times as there are additional available content/advertisement.

While not shown, any content/advertisement(s) may be initially hidden and then accessed via a pull down screen (which is also initially hidden) until a user initiates a vertical downward swipe gesture that originates at a top of the screen, to virtually cover the graphics of the current graphics display with the pull down screen. As an option, an icon and/or text (e.g., possibly in connection with a virtual pull down screen tab, etc.) may be displayed to prompt a user to initiate the aforementioned vertical downward swipe gesture that originates at a top of the screen (e.g., possibly on the virtual pull down screen tab, etc.). In another embodiment, an icon (like the photo-icon shown and/or a supplement or substitute therefor) may be displayed at a bottom of the screen to prompt a user to initiate a vertical upward swipe gesture that originates at a bottom of the screen (e.g., on the icon, etc.) for virtually uncovering the ad/content by removing the graphics of the current graphics display (e.g., possibly without having to “slide to unlock” the screen, etc.).

While not shown, the above ad/content techniques disclosed in the context of FIG. 11 may be applied in the context of screens other than a lock screen, etc. For instance, the above ad/content techniques disclosed in the context of FIG. 11 may be applied to a phone call interface that is displayed while a phone call is active. In such embodiment, the ad/content and/or related icons/selectors, etc. may be displayed simultaneously with phone options such as a mute icon, conference call icon, merge call icon, etc. In another embodiment, the above ad/content techniques disclosed in the context of FIG. 11 may be applied to a voice mail interface that is displayed before and/or while and/or after a voicemail is being audibly presented. For that matter, such techniques may be displayed in the context of any screen in which the mobile user is not using (or heavily using) an interface.

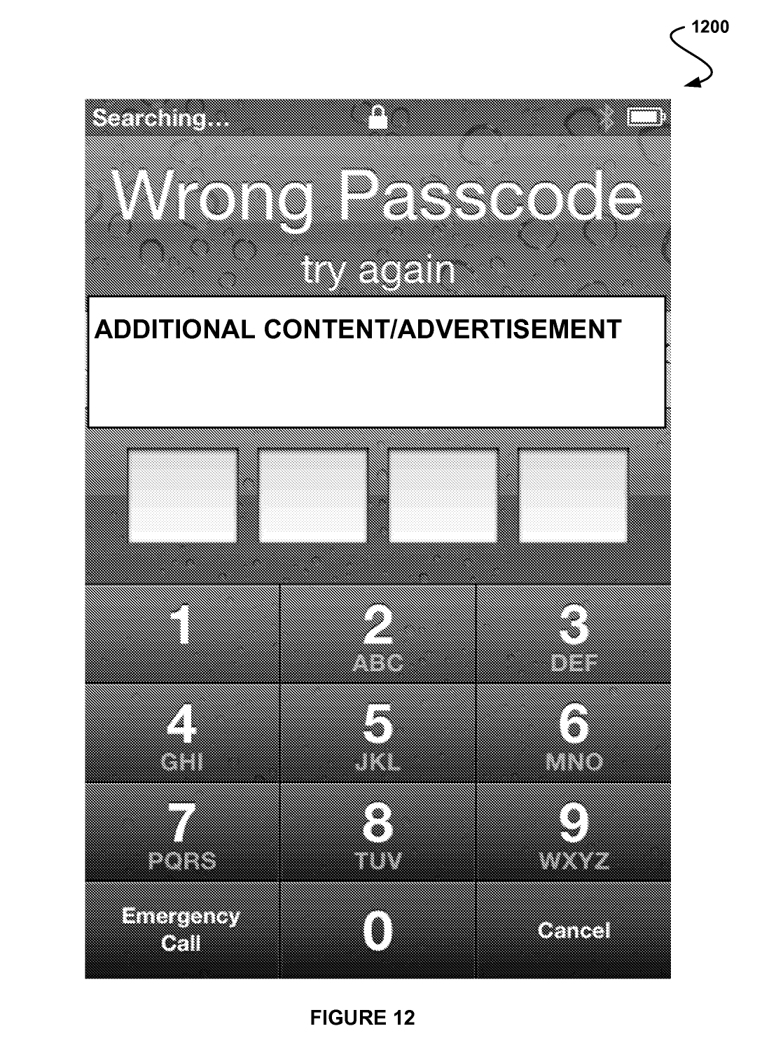

FIG. 12 shows a mobile device interface 1200 for displaying advertisements/content, in accordance with another embodiment. As an option, the interface 1200 may be implemented in the context of the architecture and environment of the previous Figures and/or any subsequent Figure(s). For example, any of the ad/content techniques disclosed in the context of FIG. 11 may be applied in the present interface 1200. Of course, however, the interface 1200 may be implemented in the context of any desired environment. It should also be noted that the aforementioned definitions may apply during the present description.

As shown, the interface 1200 may be capable of displaying additional content/advertisements when an incorrect passcode has been entered. In one embodiment, the additional content/advertisement may include information related to the advertisement/content displayed on the initial screen/display. In another embodiment, the additional content/advertisement may include another advertisement/content, unrelated to the advertisement/content displayed on the initial screen/display. In one embodiment, the additional content/advertisement may be able to be selected by the user such that additional information is displayed. Of course, in various embodiments, any type of information may be displayed as part the additional context/advertisement.

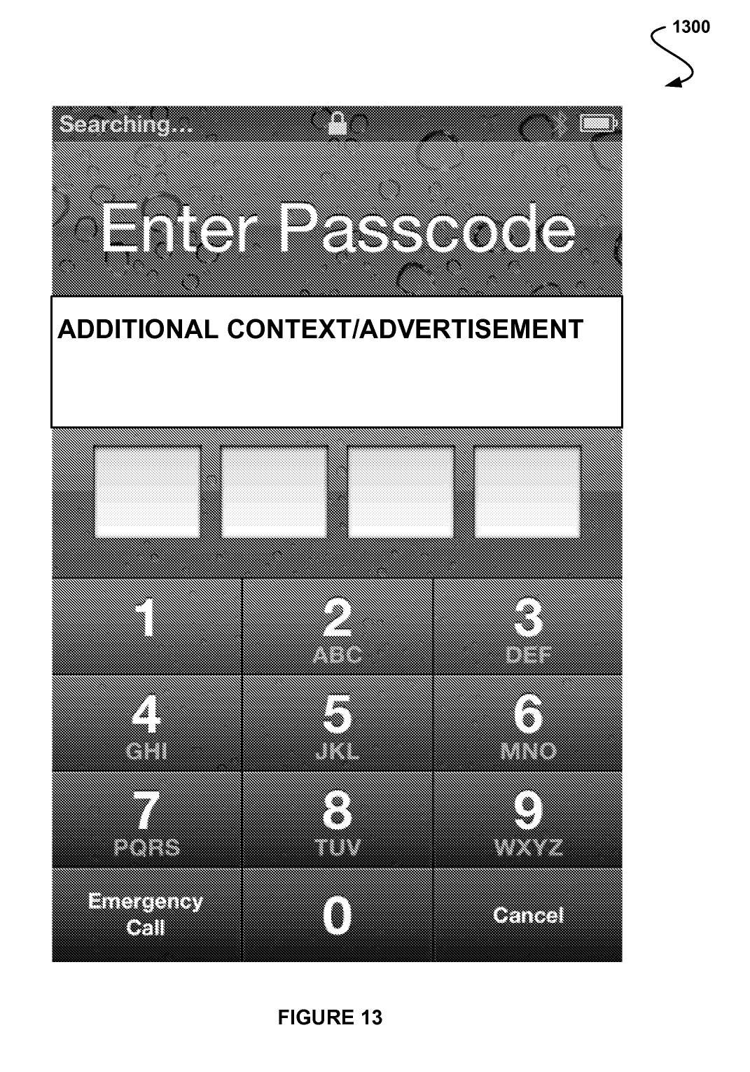

FIG. 13 shows a mobile device interface 1300 for displaying advertisements/content, in accordance with another embodiment. As an option, the interface 1300 may be implemented in the context of the architecture and environment of the previous Figures and/or any subsequent Figure(s). For example, any of the ad/content techniques disclosed in the context of FIG. 11 may be applied in the present interface 1200. Of course, however, the interface 1300 may be implemented in the context of any desired environment. It should also be noted that the aforementioned definitions may apply during the present description.

As shown, the interface 1300 may be capable of displaying additional content/advertisements at a password entry screen. In one embodiment, the additional content/advertisement may include information related to the advertisement/content displayed on an initial screen/display. In another embodiment, the additional content/advertisement may include another advertisement/content, unrelated to the advertisement/content displayed on the initial screen/display. In one embodiment, the additional content/advertisement may be able to be selected by the user such that additional information is displayed. Of course, in various embodiments, any type of information may be displayed as part the additional context/advertisement.

In one embodiment, upon successful entry of the password, the advertisement/content may be escalated. In another embodiment, upon successful entry of the password, a home screen including a plurality of application icons may be displayed. In one embodiment, at least one of the plurality of application icons may include an application icon associated with displaying available context/advertisements.

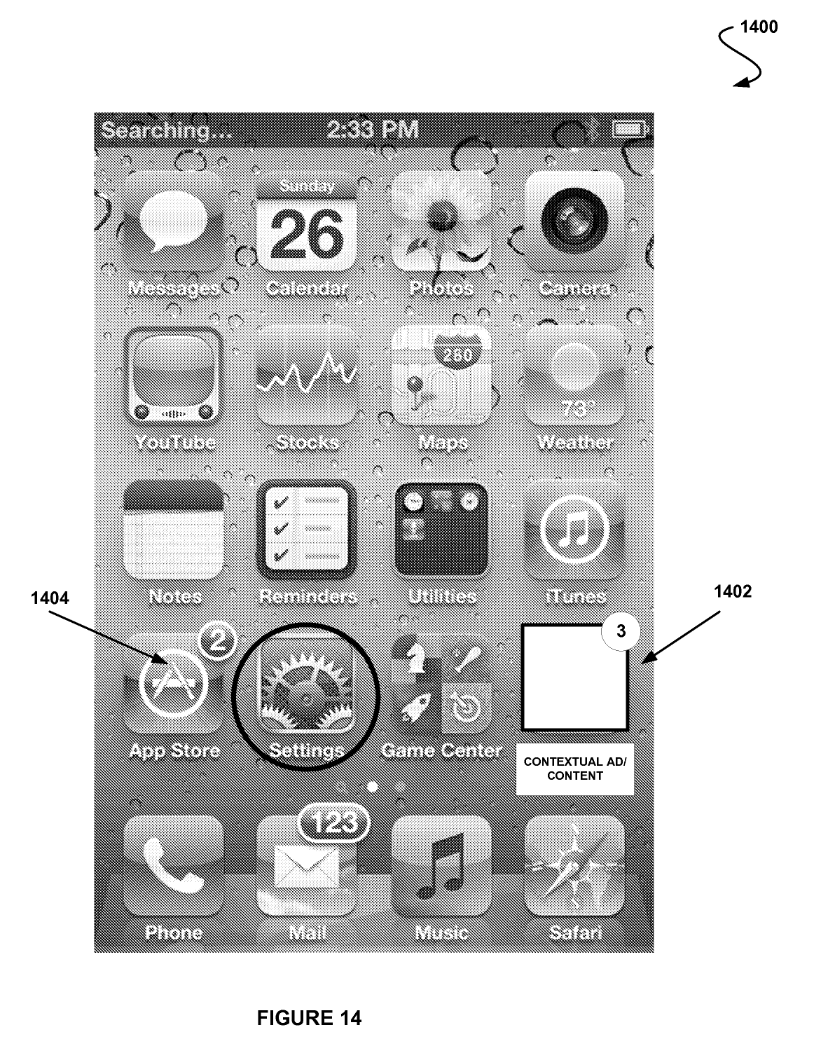

FIG. 14 shows a mobile device interface 1400 for displaying advertisements/content, in accordance with another embodiment. As an option, the interface 1400 may be implemented in the context of the architecture and environment of the previous Figures and/or any subsequent Figure(s). Of course, however, the interface 1400 may be implemented in the context of any desired environment. It should also be noted that the aforementioned definitions may apply during the present description.

As shown, the interface 1400 includes a home screen capable of displaying a plurality of application icons. In one embodiment, at least one of the plurality of application icons may include an application icon associated with displaying available context/advertisements (e.g., application icon 1402). As an option, the application icon associated with displaying available context/advertisements may include an indicator capable of indicating a number of advertisements/content available for viewing. In one embodiment, upon selection of the icon, a list of advertisements/content may be provided. In another embodiment, upon selection of the icon, the advertisements/content may be displayed on the display screen of the mobile device.

Further, in one embodiment, the at least one of the plurality of application icons may include an application icon associated with displaying available feeder applications (e.g., application icon 1404). For example, in one embodiment, when the user enters a location or area associated with a feeder application, the application icon associated with displaying available feeder application may display an indicator (or increment an indicator, etc.) of the application icon associated with displaying available feeder applications.

Additionally, in one embodiment, a “Settings” icon may be utilized to configure contextual advertisement/content alerts, etc. Furthermore, in one embodiment, the “Settings” icon may be utilized to configure feeder application download/execution.

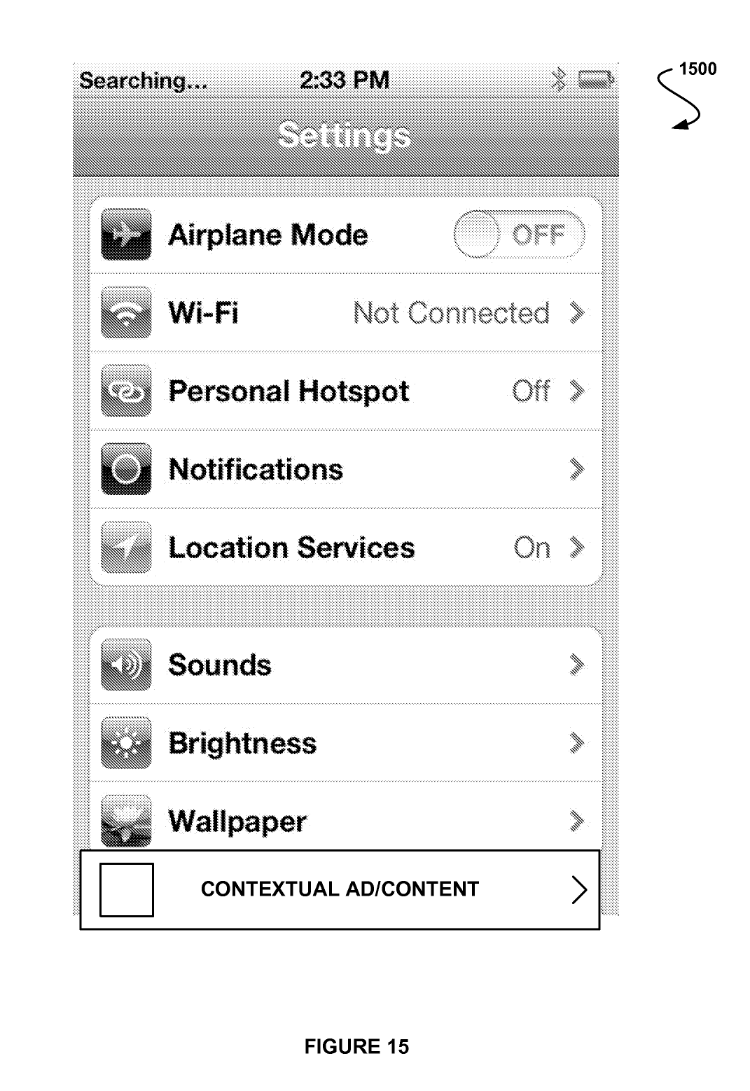

FIG. 15 shows a mobile device interface 1500 for configuring advertisement/content display, in accordance with another embodiment. As an option, the interface 1500 may be implemented in the context of the architecture and environment of the previous Figures and/or any subsequent Figure(s). Of course, however, the interface 1500 may be implemented in the context of any desired environment. It should also be noted that the aforementioned definitions may apply during the present description.

In one embodiment, the interface 1500 may be displayed when a “Settings” icon is selected on a main screen of a mobile device. In one embodiment, the interface 1500 may present a user the option to configure/modify settings associated with contextual advertisements and/or content. In one embodiment, the interface 1500 may present a user the option to configure how/if content is displayed on the mobile device. For example, in various embodiments, by selecting the contextual advertisement/content setting option on the interface 1500, a user may be able to indicate whether advertisements/content are to be displayed, indicate a type of advertisements/content that are to be displayed, indicate whether an advertiser/content provider is allowed to receive personal information for targeted advertisements/content (e.g., utilizing feeder applications, etc.), indicate whether location information associated with the mobile device is to be shared with the advertisement/content provider, configure audio/visual settings associated with advertisement/content display, and/or configure a variety of other settings associated with the advertisement/content.

Further, in one embodiment, the interface 1500 may present a user the option to configure/authorize automatic download/execution of feeder applications. For example, in various embodiments, the settings may include allowing the authorization of the search for feeder applications, authorizing the automatic download of feeder applications, authorizing the automatic execution of feeder applications, authorizing the sharing of information between feeder applications and an advertisement platform, and/or various other settings associated with feeder applications.

Still yet, in one embodiment, a notifications option associated with the settings may include an option to configure how advertisements/content are presented. In another embodiment, the notifications option associated with the settings may include an option to configure whether notifications associated with advertisement/content and/or feeder applications are to be presented.

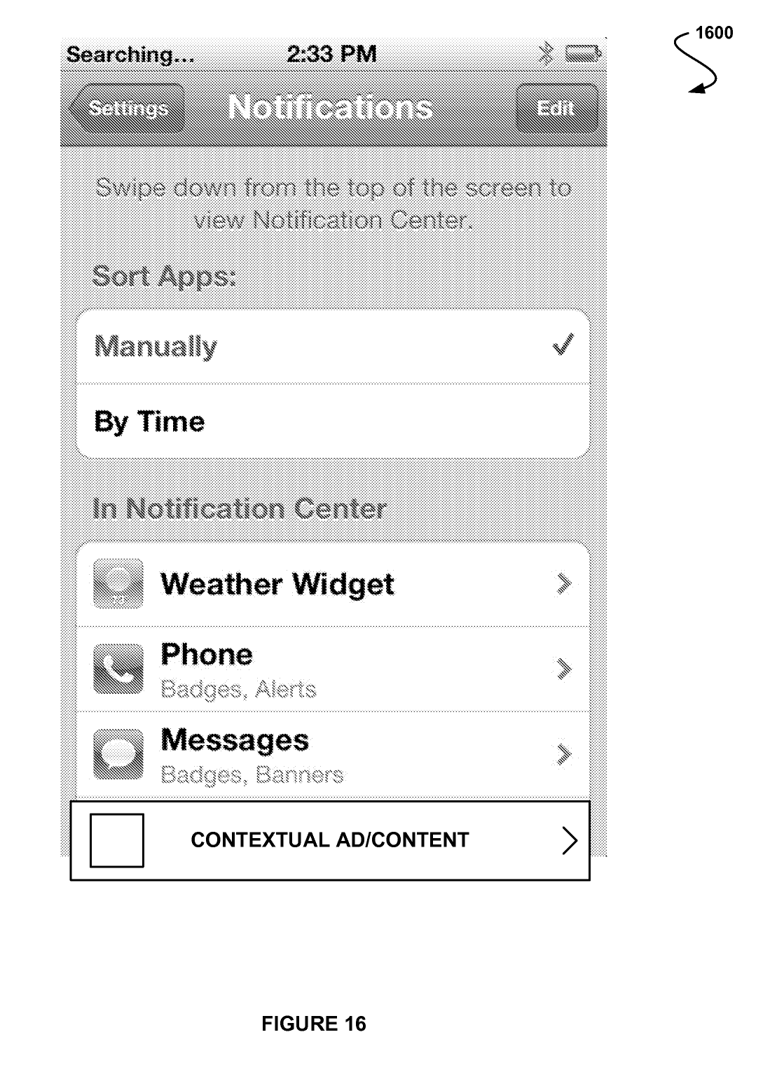

FIG. 16 shows a mobile device interface 1600 for configuring advertisement/content related notifications, in accordance with another embodiment. As an option, the interface 1600 may be implemented in the context of the architecture and environment of the previous Figures and/or any subsequent Figure(s). Of course, however, the interface 1600 may be implemented in the context of any desired environment. It should also be noted that the aforementioned definitions may apply during the present description.

In one embodiment, the interface 1600 may be utilized to select a contextual advertisement/content notification option. In one embodiment, the contextual advertisement/content notification option may be utilized to turn notifications associated with the contextual advertisement/content on and off. In one embodiment, a similar notification option may be available for feeder applications. In this case, in one embodiment, notifications associated with feeder applications (e.g., availability notifications, information sharing notifications, etc.) may be turned on or off. Further, in one embodiment, the settings may function to allow the user to configure a location and/or manner in which the notifications associated with feeder applications, advertisements, and/or content are displayed.

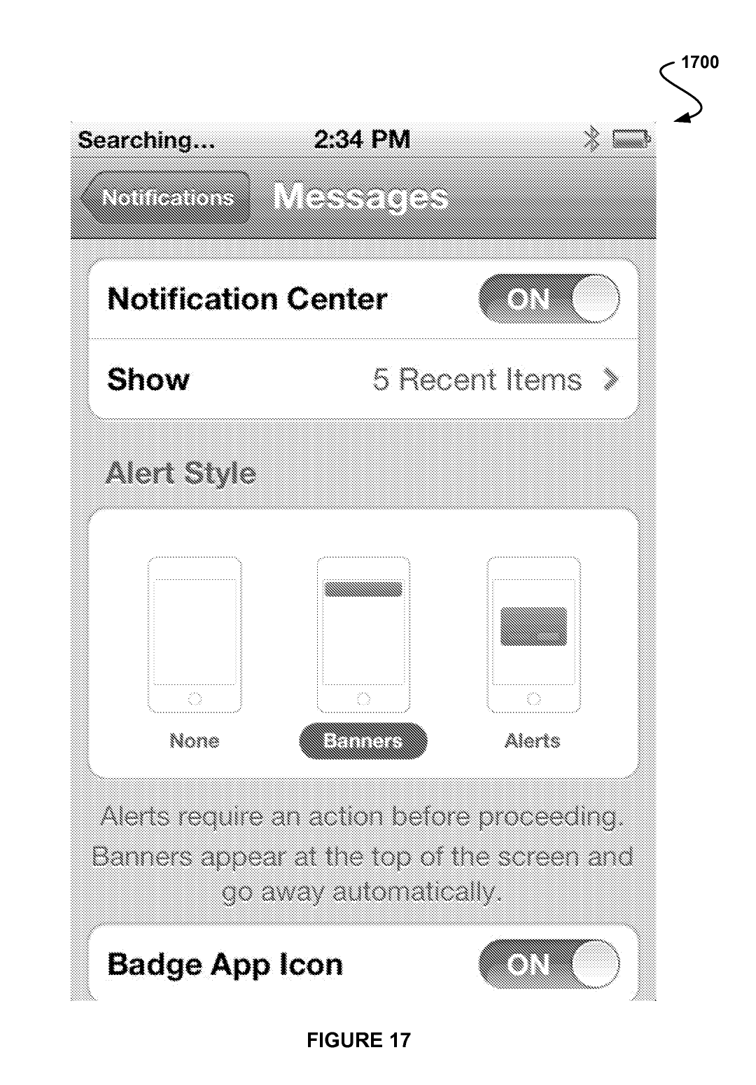

FIG. 17 shows a mobile device interface 1700 for configuring advertisement/content related notifications, in accordance with another embodiment. As an option, the interface 1700 may be implemented in the context of the architecture and environment of the previous Figures and/or any subsequent Figure(s). Of course, however, the interface 1700 may be implemented in the context of any desired environment. It should also be noted that the aforementioned definitions may apply during the present description.

As shown, in one embodiment, the alert style for the advertisements/content may be selected by a user of a mobile device. In various embodiments, the style of the alert, notification, advertisement, and/or content may be selected to be a banner style, an alert style, a scrolling banner style, a flashing alert style, a stationary alert style, and/or various other alert styles. Similarly, in one embodiment, an alert and/or notification style associated with a feeder application notification may be selected.

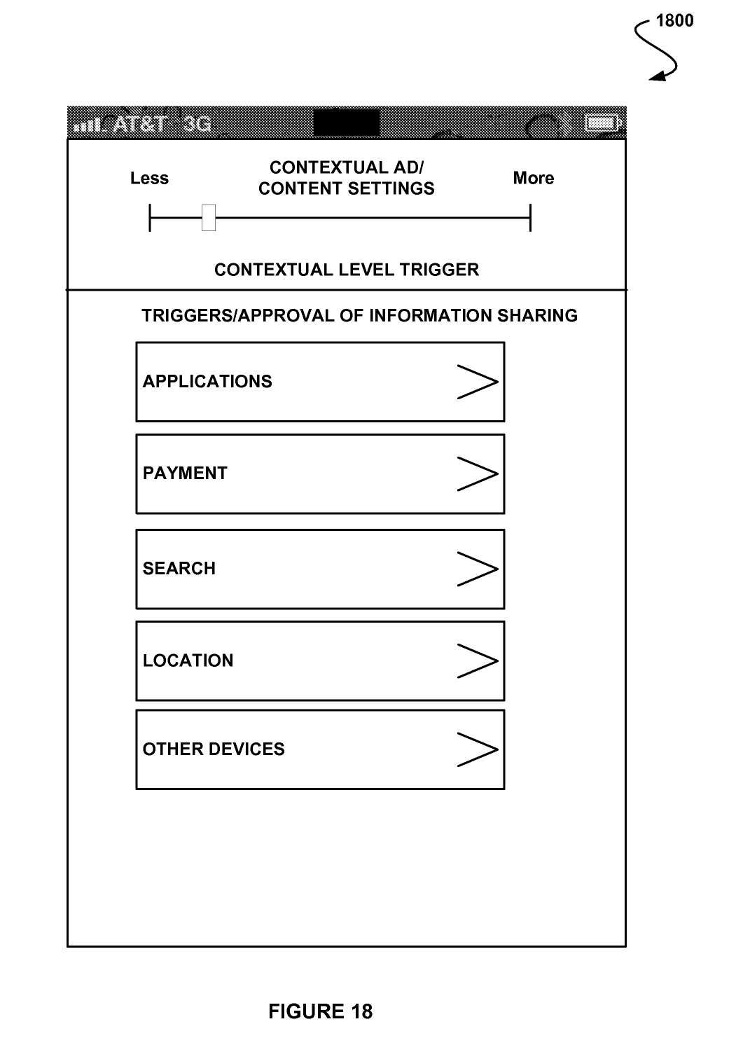

FIG. 18 shows a mobile device interface 1800 for configuring advertisement/content related settings, in accordance with another embodiment. As an option, the interface 1800 may be implemented in the context of the architecture and environment of the previous Figures and/or any subsequent Figure(s). Of course, however, the interface 1800 may be implemented in the context of any desired environment. It should also be noted that the aforementioned definitions may apply during the present description.

In one embodiment, the interface 1800 may be utilized to set a level for an amount of contextual advertisement/content settings to be displayed to a user. In this way, the user may have the ability to control the amount and/or relevancy of advertisements/content displayed to the user. Although, in one embodiment, the amount and/or relevancy of content/advertisements may be controlled utilizing a slide-able scale interface (e.g., as shown in FIG. 18), in various other embodiments, a dial may be utilized, a specific number per day/week may be inputted, and/or various other control techniques may be utilized.

In one embodiment, the selector may relate to a plurality of the previously disclosed criteria (e.g., time, location, etc.). For example, by moving the slider in one particular direction, a distance from a particular location and a time within a predetermined time would have to be less, in order to trigger content/ad. Conversely, by moving the slider in another particular direction, the distance from the particular location and the time within the predetermined time could be more.

Of course, in other embodiments, multiple selectors may be displayed (e.g., one for each of a plurality of the criteria disclosed prior, etc.). For example, by moving the slider in one particular direction, a distance from a particular location would have to be less, in order to trigger content/ad. Conversely, by moving the slider in another particular direction, the distance from the particular location could be more.

Further, in one embodiment, the interface 1800 may be utilized to set one or more preferences associated with sharing. For example, in one embodiment, the interface 1800 may be utilized to set sharing preferences associated with applications (e.g., feeder applications, etc.). In various embodiments, the sharing preferences may include allowing information to be shared between various feeder applications, allowing information to be shared with feeder applications, allowing information to be shared between one or more master applications and one or more feeder applications, allowing information to be shared between an operating system and one or more feeder applications, allowing information to be shared between an operating system and one or more master applications, allowing information to be shared between an advertisement application/platform and one or more feeder applications, allowing information to be shared between an advertisement application/platform and one or more master applications, allowing information to be shared between an advertisement application/platform and one or more operating systems, and/or allowing information to be shared between various other applications.

Further, in one embodiment, the interface 1800 may be utilized to set sharing preferences associated with payment applications and/or activity. For example, in one embodiment, the interface 1800 may be utilized to set sharing preferences associated with a mobile wallet. In another embodiment, the interface 1800 may be utilized to set sharing preferences associated with purchase activity (e.g., online shopping, in-store shopping, etc.).

In yet another embodiment, the interface 1800 may be utilized to set sharing preferences associated with one or more search engines. For example, in various embodiments, the interface 1800 may be utilized to set sharing preferences associated with key word searches, viewed websites, viewed/searched products/services, viewed/searched locations, and/or any other search related information.

In another embodiment, the interface 1800 may be utilized to set sharing preferences associated with location information. For example, in various embodiments, the interface 1800 may be utilized to authorize or de-authorize the sharing of location information with applications, advertisement platforms, social networking systems/applications, and/or various other systems.

Further, in one embodiment, the interface 1800 may be utilized to set sharing preferences associated with other devices. In various embodiments, the other devices may include other devices associated with the user of the mobile device and/or devices controlled by a third party (e.g., another user, a business, etc.). For example, in various embodiments, the other devices may include mobile phones, tablet computers, desktop computers, set-top boxes, televisions, appliances, networked servers, billboards, in-store displays, and/or any other type of device.

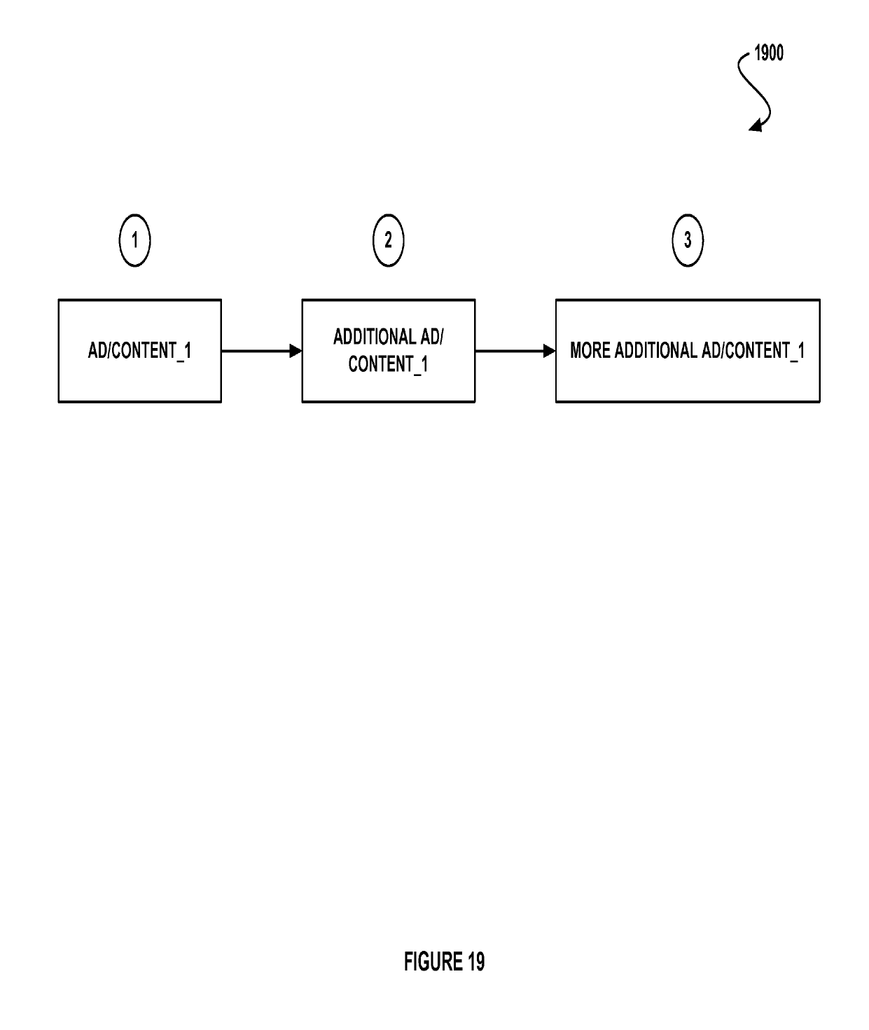

FIG. 19 shows an advertisement interface flow 1900, in accordance with another embodiment. As an option, the flow 1900 may be implemented in the context of the architecture and environment of the previous Figures and/or any subsequent Figure(s). Of course, however, the flow 1900 may be implemented in the context of any desired environment. It should also be noted that the aforementioned definitions may apply during the present description.

As shown, the advertiser interface may display a first contextual advertisement/content initially. Upon interest by a viewer (or escalation based on defined criteria, etc.), additional related advertisements/content may be displayed. Upon further interest by the viewer (or escalation based on defined criteria, etc.), more additional related advertisements/content may be displayed.

In one embodiment, escalation from the contextual advertisement/content of step 1 to the additional related contextual advertisement/content of step 2 (or from step 2 to step 3, etc.), may occur upon an explicit expression of interest from the viewer. In one embodiment, the explicit expression of interest may include a selection of the advertisement/content (e.g., by clicking the advertisement, etc.). In another embodiment, the explicit expression of interest may include an audible utterance indicating interest (e.g., “that advertisement looks interesting,” “show me more,” etc.). In another embodiment, the explicit expression of interest may include the viewer selecting a “Like” icon associated with the advertisement/content. In another embodiment, the explicit expression of interest may include the viewer selecting an option to display an additional related advertisement/content.

In one embodiment, display of additional related content may require user authentication. In various embodiments, the user authentication may include the user entering a password/passcode, speaking a password/passcode, providing biometric information, and/or providing various other information.

In another embodiment, escalation from the contextual advertisement/content of step 1 to the additional related contextual advertisement/content of step 2 (or from step 2 to step 3, etc.), may occur upon an implied expression of interest from the viewer. In various embodiments, the implied expression of interest may include viewer eye contact with the advertisement/content for a predetermined amount of time (e.g., a detected by a camera associated with the device, etc.), the user scrolling through an advertisement/content (e.g., or illuminating the advertisement/content, etc.) one or more times, the user leaving the content /advertisement on the display without removing or closing the advertisement for a predetermined amount of time, the user sharing the advertisement/content with another user (e.g., utilizing a share option, a text message, an email, etc.), the user capturing a screen shot displaying the advertisement, the user performing a search (e.g., on a browser, etc.) for information associated with the content/advertisement, and/or any other implied expression of interest from the viewer.

In one embodiment, the escalation from the additional contextual advertisement/content of step 2 to the more additional advertisement content of step 3 may be based on the same criteria as the escalation from step 1 to step 2. In another embodiment, the escalation from the additional contextual advertisement/content of step 2 to the more additional advertisement content of step 3 may be based on different criteria than the escalation from step 1 to step 2 (e.g., a password may be required for escalation, survey questions may need to be answered, etc.).

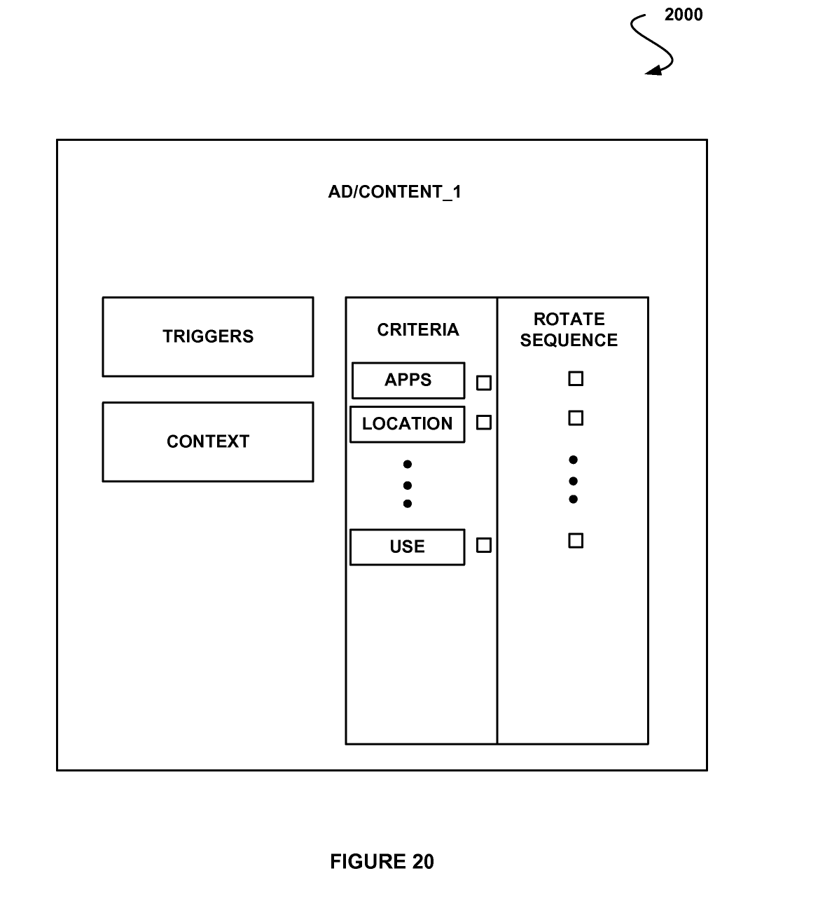

FIG. 20 shows an advertisement interface 2000, in accordance with another embodiment. As an option, the interface 2000 may be implemented in the context of the architecture and environment of the previous Figures and/or any subsequent Figure(s). Of course, however, the interface 2000 may be implemented in the context of any desired environment. It should also be noted that the aforementioned definitions may apply during the present description.

As shown, in one embodiment, the advertisement interface 2000 may be utilized to set triggers for targeted advertisements/content. Further, in one embodiment, the interface 2000 may be utilized to select different criteria for displaying/selecting an advertisement/content. Additionally, in one embodiment, the interface 2000 may be utilized to change/identify a context associated with an advertisement/content.

In one embodiment, the interface 2000 may be utilized by advertisers to set triggers for advertisements/content. In various embodiments, the advertisements/content may be triggered. In one embodiment, the advertisements may be triggered as a sequence. In various embodiments, the advertisement/content may be triggered based on current and/or historic activity. Further, in various embodiments, the triggers may be configured utilizing Boolean operators and or Macros. For example, in one embodiment, a macro may be user to display content on a mobile device instead of utilizing the advertiser interface.

The advertisements/content may be configured to trigger based on a variety of criteria. For example, in one embodiment, the advertisement/content may be configured to trigger on a location associated with the user and/or the mobile device. In various embodiments, the location may include a current or past location. In various embodiments, the location of the mobile device/user may be determined by GPS, a network being utilized, a post by a user (e.g., on a social network website, etc.), a check-in by a user (e.g., utilizing a mobile device, etc.).

More information regarding determining a user location, etc. may be found in U.S. Provisional Patent Application No. 61/590,767, filed Jan. 25, 2012, titled “SYSTEM, METHOD AND COMPUTER PROGRAM PRODUCT FOR LOCATION-SPECIFIC PRIVACY SETTINGS;” U.S. Provisional Patent Application No. 61/591,819, filed Jan. 27, 2012, titled “SYSTEM, METHOD, AND COMPUTER PROGRAM PRODUCT FOR ALTERING AT LEAST ONE ASPECT OF AN INTEGRATED E-COMMERCE ON-LINE APPLICATION;” and U.S. Provisional Patent Application No. 61/596,174, filed Feb. 7, 2012, titled “SYSTEM, METHOD, AND COMPUTER PROGRAM PRODUCT FOR ALTERING AT LEAST ONE ASPECT OF AN INTEGRATED E-COMMERCE ON-LINE APPLICATION.”

The location associated with advertisements and/or feeder applications may be determined utilizing a variety of techniques. For example, in various embodiments, the location may include a location determined by an advertiser, business, and/or application provider. In one embodiment, the location may be defined by a perimeter. In one embodiment, the perimeter may be defined utilizing a GUI for drawing a perimeter.

In another embodiment, the location may include a circular area that is a defined radius from a point (e.g., a business, a landmark, etc.). Further, in one embodiment, the radius may be defined by the capacity of a signal strength associated with the network. In another embodiment, the location may include a building. In another embodiment, the location may include a building and a perimeter that is a predefined distance from the building.

More information regarding location definition and determination may be found in U.S. Provisional Patent Application No. 61/511,750, filed Jul. 26, 2011, titled “SYSTEM, METHOD, AND COMPUTER PROGRAM PRODUCT FOR MANAGING A SOCIAL NETWORK BASED ON AT LEAST A TIME OR A LOCATION,” and U.S. patent application Ser. No. 13/557,198, filed Jul. 24, 2012, titled “SYSTEM, METHOD, AND COMPUTER PROGRAM PRODUCT FOR MANAGING A SOCIAL NETWORK BASED ON AT LEAST A TIME OR A LOCATION,” which are incorporated by reference in their entirety.

In one embodiment, the location may be based on a future location associated with the user and/or the mobile device. For example, in one embodiment, the future location may be determined based on user provided information to a social networking site. In another embodiment, the future location may be determined based on a future reservation. For example, a user may have made a reservation utilizing a mobile device and the mobile device (or an application associated therewith, etc.) may log the reservation information to utilize to determine a future location. In another embodiment, a calendar application may be utilized to automatically determine a future location of the user/mobile device.

In another embodiment, a navigation system and/or mapping application may be utilized to determine the future location of the user/mobile device. For example, in one embodiment, a movement vector associated with the mobile device may be determined. In one embodiment, the movement vector may be determined by utilizing a velocity and a direction associated with the mobile device (e.g., utilizing GPS, etc.). In another embodiment, the movement vector may be determined by utilizing a velocity and a direction associated with a vehicle. In one embodiment, the mobile device and the vehicle may share location/direction related information.

In one embodiment, future location may be determined utilizing a movement vector in combination with one or more road maps, recent route requests, a mapping application, and/or, navigation information from a vehicle, etc. In one embodiment, a determined potential future location may be utilized to present a user with advertisements, content, and/or applications. For example, in one embodiment, it may be determined a potential future location is a theme park. In this case, a user may be presented with discounts/advertisements associated with the theme park. Similarly, in one embodiment, it may be determined that a potential future location is a restaurant. In this case, in one embodiment, an application associate with the restaurant may be presented to the user on the mobile device for download (e.g., a menu application, etc.).

In another embodiment, advertisements may be displayed on the mobile device based on a route of the user. For example, if it is determined that a user may be travelling past on or more businesses (e.g., gas stations, retail stores, etc.), advertisements associated with those businesses may be displayed on the mobile device while the user is in route.

In another embodiment, it may be determined whether a mobile device has been at a location previously. For example, in one embodiment, the mobile device and/or a system associated with the location may log if/when the mobile device has been within a zone defined as the location. Further, in one embodiment, activities of the user performed at the location (e.g., purchase activities, application user activity, etc.) may be logged. In one embodiment, the information logged may be utilized to choose content/advertisements to present to the user utilizing the mobile device and/or displays associated with the location.

In one embodiment, if it is determined that the user has never been to the location (e.g., based on the logged data, etc.), advertisements, content, and/or applications may be selected accordingly. For example, in one embodiment, if it is determined that the user has never been to a particular location, it may be determined that the user is a first time visitor (e.g., or tourist, etc.) and information for first time visitors may be provided to the user via the mobile device (e.g., tourist information, maps of a facility, menu options, etc.).

In another embodiment, communications may be utilized as criteria for triggering advertisements. In various embodiments, the communications may include text messages, emails, VOIP calls, spoken dialogue, social network site posts, and/or any other type of communication capable of being captured by a mobile device. In one embodiment, keywords in the communication may be extracted and may be used to select advertisements/content. For example, if the word “doctor” is presented in a communication, advertisements for local physicians may be presented to the user on the mobile device (e.g., utilizing a current location of the user, etc.). Similarly, if the words “new car” are presented in a communication, advertisements for local car dealers may be presented to the user on the mobile device (e.g., utilizing a current location of the user, etc.). In various embodiments, the advertisements/content may be presented based on current and/or past communications.

In another embodiment, the criteria for selecting and/or triggering advertisements, content, and or application suggestions may be based on one or more captured images. For example, in one embodiment, a user may capture one or more images on the mobile device and one or more image/object recognition techniques may be utilized to identify one or more objects/items/people/locations. In one embodiment, based on the identified objects/items/people/locations, advertisement, content, and/or applications may be presented to the user utilizing the mobile device. In various embodiments, the captured image(s) may include one or more stored images, one or more currently captured images, and/or video, etc.

More information associated with image/object recognition techniques may be found in U.S. Provisional Patent Application No. 61/612,960, filed Mar. 19, 2012, titled “SYSTEM, METHOD, AND COMPUTER PROGRAM PRODUCT FOR ALTERING AT LEAST ONE ASPECT OF AN EXPERIENCE OF A VIEWER IN ASSOCIATION WITH A TELEVISION,” which is incorporated herein by reference in its entirety.

Furthermore, in one embodiment, purchases and/or payments made by the user may be utilized as criteria for selecting and/or triggering advertisements. In one embodiment, the purchases and/or payments may include current purchases and/or payments. In another embodiment, the purchases and/or payments may include past purchases and/or payments.

In various embodiments, the purchases and/or payments may be facilitated and/or detected utilizing one or more applications associated with a retailer, a social network, a mobile wallet, a bank, a payment service, a product provider, a service provider, and/or any other type of application capable of facilitating and/or detecting one or more purchases. Further, in one embodiment, the payment/purchase information may be utilized to determine whether the payment/purchase is a reoccurring payment/purchase. In one embodiment, if it is determined that the payment is a reoccurring payment/purchase, then reminders, advertisements, content, discounts, etc., associated with the reoccurring payment/purchase may be selected and/or displayed.

In another embodiment, application use may be used to select and/or trigger advertisements/content. For example, one or more advertisements/content may be triggered and/or selected based on the type of applications being utilized by a user on a mobile device. In one embodiment, the application use may include current application use. In another embodiment, the application use may include past application use. The applications may include any type of application. For example, in various embodiments, the applications may include games, shopping applications, media applications, travel applications, mobile wallet applications, web browsing applications, and/or any other type of application. In one embodiment, a duration of application use may be used to select and/or trigger advertisements/content or other application suggestions.

In another embodiment, big data may be used to select and/or trigger advertisements/content. For example, in one embodiment, data from other mobile devices may be utilized to select and/or trigger advertisements/content on a mobile device associated with the user. In one embodiment, the data may include data from mobile devices within a radius from the mobile device of the user. Additionally, in one embodiment, the data may include data from devices in the same location as the mobile device of the user (e.g., in the same building, at the same stadium, at the same airport, etc.). In various embodiments, the big data may include location data, movement data, weather data, application usage data, purchase data, personal data, and/or any other type of data. In one embodiment, an application on the mobile device of the user may facilitate the polling of data associated with the other mobile devices. Further, in one embodiment, the other devices may send information to a networked server, such that the mobile device associated with the user may access the data (or a summary, etc.). In yet another embodiment, the other devices may send data to the mobile device.

Further, in one embodiment, social data may be used to select and/or trigger advertisements/content (e.g., people/friends with the user, a number of people at a location, etc.). For example, in one embodiment, it may be determined whether a first user is with any other users. In one embodiment, it may be determined that the first user is close to other users based on GPS locations associated with the users. In another embodiment, it may be determined that the first user is close to other users based on social network information associated with the users (e.g., check-in status, posts, etc.). In another embodiment, it may be determined that the first user is close to other users based on a signal associated with the devices of the users (e.g., cell signals, Bluetooth signals, Wi-Fi signals, etc.). In various embodiments, any type of information associated with the users may be utilized, such as gender, age, race, interests, relationship status, and/or any other type of information. In one embodiment, it may be determined that the users are friends utilizing social network information. In one embodiment, utilizing the information obtained from all or some of the users, advertisement/content may be presented to the first user and/or the other users. For example, in one embodiment, if it is determined that the users are friends, one or more of the users may be presented with one or more advertisements for businesses in the area. In one embodiment, discounts may be presented to one or more of the users, based on the number of people in the group. For example, in one embodiment, at least one member of a group of four friends may be presented with an advertisement for a discount if all four people go to a particular establishment.

More information regarding group incentivized discounts may be found in U.S. Provisional Patent Application No. 61/590,767, filed Jan. 25, 2012, and titled “SYSTEM, METHOD AND COMPUTER PROGRAM PRODUCT FOR LOCATION-SPECIFIC PRIVACY SETTINGS.” In one embodiment, the aforementioned friends may include “temporary” friends that may be “friended” (i.e., an association made, etc.) for a temporary pre-configured and/or user configured time period.

In another embodiment, user interest (e.g., explicit user interest, implicit user interest, etc.) may be used to select and/or trigger advertisements/content. For example, in one embodiment, a user may say (e.g., to the mobile device, to in a manner received by the user device, etc.), “I am interested in cars.” Accordingly, in one embodiment, advertisements/content associated with cars may be presented to the user on the mobile device. In another embodiment, the user may take photos of cars using the mobile device. Accordingly, in one embodiment, an interest in cars may be inferred and advertisements/content associated with cars may be presented to the user on the mobile device. Similarly, in one embodiment, the user may purchase tickets to a car show. In this case, an interest in cars may be inferred and advertisements/content associated with cars may be presented to the user on the mobile device.

More information regarding determining interests/habits of a user may be found in U.S. Provisional Patent Application Number 61/481,722, filed May 5, 2011, titled “SYSTEM, METHOD, AND COMPUTER PROGRAM PRODUCT FOR ALLOCATING TIME TO ACHIEVE OBJECTIVES;” and U.S. patent application Ser. No. 13/462,804, filed May 2, 2012, titled “SYSTEM, METHOD, AND COMPUTER PROGRAM PRODUCT FOR ALLOCATING TIME TO ACHIEVE OBJECTIVES,” which are incorporated herein by reference in their entirety.

In another embodiment, automatically recognizable macros may be used to select and/or trigger advertisements/content. For example, in one embodiment, it may be determined that a user performs a series of actions regularly utilizing a mobile device (e.g., more than 2 times, more than 3 times, periodically, etc.). In various embodiments, one or more advertisements, content, and/or applications may be selected and/or presented, based on the determination.

As one example, a user may have repeated search for a local pizza place on a mobile device, then look up coupons/specials associated with the pizza place, select the coupons, call the pizza place, and submit an order. In one embodiment, an advertisement platform (or an OS, application, etc.) associated with the mobile device may recognize the pattern and automatically select/display advertisements/coupons for the local pizza place. In one embodiment, the advertisement may allow the user to select the advertisement/coupon, such that an order is automatically facilitated (e.g., a web order, an email order, a phone order, etc.). In another embodiment, an advertisement platform (or an OS, application, etc.) associated with the mobile device may recognize the pattern and automatically select/display an application associated with the local pizza place.

In one embodiment, restrictions may be set such that only certain companies may serve advertisements in a location. In another embodiment, there may be restrictions such that certain companies/advertisers (e.g., COKE, etc.) are the only companies/advertisers that may trigger advertisements/content in connection with an application. For example, in one embodiment, COMPANY_1 may be configured to be an exclusive advertiser corresponding to an application associated with COMPANY_1. In another embodiment, COMPANY_1 may be configured to be an exclusive advertiser (or one advertiser of a selected few, etc.) corresponding to an application associated with COMPANY_2. In one embodiment, COMPANY_1 may sell advertising space to COMPANY_2, the advertising space being associated with an application corresponding to COMPANY_1.

In one embodiment, advertisers/companies may have the ability to receive suggestions utilizing the interface 2000. For example, in one embodiment, when advertisers/companies drill down in each criteria, the advertisers may be presented suggestions based on analysis of an advertisement.

In one embodiment, advertisers/companies may perform keyword searches, etc., to receive suggested criteria. Further, in one embodiment, the advertiser may have the ability to perform test runs to see how many people would have received the advertisement based on back-testing. Additionally, in one embodiment, the advertisements may be actually shown the situations/scenarios that would have been triggered.

Still yet, in one embodiment, instead of displaying advertisements/content on the mobile device, the advertisements/content may be displayed on another device (e.g., a vehicular display, a third party display, etc.). For example, in one embodiment, it may be determined that the mobile device is communicatively tethered (e.g., wirelessly, wired, etc.). In this case, in one embodiment, instead of displaying advertisements/content on the mobile device, the advertisement/content may be presented on one or more vehicular displays (e.g., a passenger display, a navigation system display, a heads-up display, etc.). Further, in one embodiment, the advertisements/content may be presented over an audio system of the vehicle (i.e., audibly, etc.).

As another example, the advertisements/content may be presented on a machine associated with the advertiser. For example, if advertiser is a gas station/oil company, and it is determined that the user is at the gas pump payment system (e.g., based on location, a wireless signal, an initiated payment [e.g., by a mobile wallet, a credit card, etc.], facial recognition, etc.).

In one embodiment, information associated with the mobile device, as well as information from third party platforms may be utilized to select/trigger advertisements/content. For example, in one embodiment, discounts at a store may be offered to a user in real time, based on user information (e.g., gender, age, etc.), as well as current store discount information.

In another embodiment, instead of displaying the advertisements/content on the mobile device of the user, the advertisement/content may be displayed on a television near the user. For example, in one embodiment, the advertisement/content may be displayed as a ticker or banner on a television, etc. In various embodiments, the mobile device may be in communication with the television via a wireless connection (e.g., Wi-Fi, Bluetooth, etc.), and/or a wired connection. In one embodiment, the mobile device may be in communication with a set-top box associated with the television.

Of course, in one embodiment, the advertisement/content may be presented on the mobile device display in a non-intrusive manner. For example, in various embodiments, the advertisements/content may be presented on the mobile device display while information/data is downloading/loading, at a main menu, on main menu if there is space not taken by icons, dead space defined by an application, at an unlock screen, during application usage, while the user is looking at the screen but not writing or reading (e.g., as determined by a camera and the eyes of the user, etc.), etc.

In various other optional embodiments, the features, capabilities, and/or technology, etc. of the television, mobile devices, and/or mobile device applications, etc. disclosed in the following patents/applications may or may not be incorporated into any of the embodiments disclosed herein: U.S. Pat. No. 8,078,397, U.S. Pat. No. 7,669,123, U.S. Pat. No. 7,725,492, U.S. Pat. No. 7,788,260, U.S. Pat. No. 7,797,256, U.S. Pat. No. 7,809,805, U.S. Pat. No. 7,827,208, U.S. Pat. No. 7,827,265, U.S. Pat. No. 7,890,501, U.S. Pat. No. 7,933,810, U.S. Pat. No. 7,945,653, U.S. Pat. No. 7,970,657, U.S. Pat. No. 8,010,458, U.S. Pat. No. 8,027,943, U.S. Pat. No. 8,037,093, U.S. Pat. No. 8,081,817, U.S. Pat. No. 8,099,433, US20080033739A1, US20080046976A1, US20090144392A1, US20090198487A1, US20100049852A1, US20100132049A1, US20100164957A1, US20100169327A1, US20100198581A1, US20100229223A1, US20100257023A1, and/or US20110044354A1. Each of the foregoing patents/applications are hereby incorporated by reference in their entirety for all purposes.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, including, for example, artificial intelligence, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

It will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals.

It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

In one embodiment, each method described above and combinations thereof may be embodied in computer executable code that, when executing on one or more computing devices, performs the acts and/or provides the capabilities thereof. In another embodiment, the methods may be embodied in systems that perform the acts and/or provides the capabilities thereof, and may be distributed across devices in a number of ways, or all of the functionality may be integrated into a dedicated, standalone device or other hardware. In another embodiment, means for performing the steps associated with the processes described above may include any of the hardware and/or software described above. All such permutations and combinations are intended to fall within the scope of the present disclosure.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer program product embodied on a non-transitory computer readable medium, comprising:
code for receiving action criteria utilizing a platform capable of advertising;
code for receiving, by the platform, information from an application; and
code for determining whether to prompt an action by the platform in connection with a mobile device, based on the action criteria and the information.

2. The computer program product of claim 1, wherein the action criteria involves at least one of aggregated data collected from a plurality of users, machine-related data, location data, payment data, social data, application usage data, event data, or search data.

3. The computer program product of claim 1, wherein the action includes at least one of an advertisement, a suggestion, or an output.

4. The computer program product of claim 1, wherein the computer program product is operable such that the action criteria is received from an advertiser and the action includes displaying an advisement.

5. The computer program product of claim 4, wherein the computer program product is operable such that the advertisement is displayed utilizing a lock screen of the mobile device.

6. The computer program product of claim 4, wherein the computer program product is operable such that the advertisement is displayed during an unlocking of a lock screen of the mobile device.

7. The computer program product of claim 4, wherein the computer program product is operable such that the advertisement is displayed based on a location associated with the mobile device.

8. The computer program product of claim 4, wherein the computer program product is operable such that the advertisement is selected based on information provided by one or more feeder applications associated with the mobile device.

9. The computer program product of claim 4, wherein the computer program product is operable such that the information provided by the one or more feeder applications associated with the mobile device includes at least one of user personal information, purchase information, social network information, online retailer information, or mobile payment information.

10. The computer program product of claim 4, wherein the computer program product is operable such that the advertisement is conditionally displayed based on a facial recognition in connection with a user of the mobile device.

11. The computer program product of claim 1, wherein the platform includes at least one of a social network platform or an operating system platform.

12. The computer program product of claim 1, wherein the application is available via the platform.

13. The computer program product of claim 1, wherein the application is available in connection with a machine.

14. The computer program product of claim 1, wherein the platform includes at least one of a social network platform or an operating system platform.

15. The computer program product of claim 1, wherein the mobile device includes at least one of a cellular phone or a tablet.

16. The computer program product of claim 1, further comprising computer code for determining whether to prompt an action by the platform in connection with device capable of display, based on a location associated with the mobile device.

17. The computer program product of claim 16, wherein the device capable of display includes at least one of a television, a display associated with a payment system, a vehicular display, or a billboard.

18. The computer program product of claim 16, wherein the device capable of display includes a third party device.

19. A method, comprising:
receiving action criteria utilizing a platform capable of advertising;
receiving, by the platform, information from an application; and
determining whether to prompt an action by the platform in connection with a mobile device, based on the action criteria and the information.

20. A system, comprising:
logic for receiving action criteria utilizing a platform capable of advertising;
logic for receiving, by the platform, information from an application; and
logic for determining whether to prompt an action by the platform in connection with a mobile device, based on the action criteria and the information.
